(19) United States
(12) Patent Application Publication
(10) Pub. No.: US 2007/0192168 A1
(43) Pub. Date: Aug. 16, 2007

(54) Map and Inventory-Based On-Line Purchases

(75) Inventor: Andrew Stephen Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/608,150

(22) Filed: Dec. 7, 2006

Related U.S. Application Data
(63) Continuation-in-part of application No. 11/562,738, filed on Nov. 22, 2006.
Application No. 11/562,738 is a continuation-in-part of application No. 11/278,123, filed on Mar. 30, 2006.
(60) Provisional application No. 60/774,177, filed on Feb. 15, 2006.

(51) Int. Cl. G07G 1/00

(52) U.S. Cl. 705/10

(57) ABSTRACT

Systems and methods for survey based qualification of keyword searches and survey based qualification of keyword advertising. A searcher provides a search query to a search engine and is presented with at least one query-specific survey question. The searcher's original query and/or response to the query-specific survey question(s) are then used to generate a list of advertisers whose in-stock inventory matches user-specified criteria. The list may be provided in the form of an interactive map.

### CROSS REFERENCE TO RELATED APPLICATIONS

The present application is a continuation-in-part of U.S. patent application Ser. No. 11/562,738, entitled “Survey Based Qualification of Keyword Searches,” filed Nov. 22, 2006. The present application is also a continuation-in-part of U.S. patent application Ser. No. 11/278,123, entitled “Survey Based Qualification of Keyword Searches,” filed Mar. 30, 2006 and also claims the benefit of U.S. Provisional Patent Application Ser. No. 60/774,177, entitled “Survey Based Qualification of Keyword Searches,” filed Feb. 15, 2006, each of which is hereby incorporated by reference in its entirety.

### BACKGROUND

The concept of conducting internet searches is well known. Often these searches are performed when a user, or searcher, submits a search query including one or more keywords to a search engine. The search engine then provides the searcher with a listing of search results, or “hit” list. The searcher may then view one or more of the “hits,” begin a new search, or move on to another activity. In some cases the hit list may include one or more advertisements from advertisers. Improved methods for providing desired products to consumers are needed. One method for increasing the likelihood that a consumer will be interested in a particular product is to provide the consumer a survey and tailoring the advertisements given to the consumer based on the survey answers.

### BRIEF DESCRIPTION OF THE DRAWINGS

FIG. 1 is a block diagram of a system for survey based qualification of keyword searches according to one embodiment of the present invention.

FIG. 2 provides a method for survey based qualification of keyword searches according to one embodiment of the present invention.

FIG. 3 is a block diagram of a system for survey based qualification of keyword advertising according to another embodiment of the present invention.

FIG. 4 provides a method for survey based qualification of keyword advertising according to one embodiment of the present invention.

FIG. 5 provides a method for survey based qualification of keyword advertising according to another embodiment of the present invention.

FIG. 6 is a block diagram of a system according to another embodiment of the present invention.

FIG. 7 is a block diagram of a system according to yet another embodiment of the present invention.

FIG. 8 is a block diagram of a system according to still another embodiment of the present invention.

FIG. 9 is a schematic screen shot of a travel-based web site incorporating a survey according to an embodiment of the present invention.

FIG. 10 is a schematic screen shot of a hotel reservation web site incorporating a survey according to an embodiment of the present invention.

FIG. 11 depicts one embodiment of a survey according to the present invention.

FIG. 12 depicts a map generated in response to a completed survey according to an embodiment of the present invention.

### DETAILED DESCRIPTION

The present disclosure provides methods and systems for conducting survey based qualification of keyword searches. For the purposes of fully understanding the presently disclosed methods and systems, it will be understood that the terms below shall have the following definitions:

Advertiser-shall mean an entity that provides an advertisement, whether or not the advertisement offers goods or services for sale.

Browser-shall mean a user interface that allows a user to interact with a networked environment. An example of a browser is the Internet Explorer® browser, offered by Microsoft, Inc (Redmond, Wash.).

Browser tool bar-shall mean a tool bar embedded in a browser such as the Google™ toolbar from Google, Inc. (Mountain View, Calif.).

Conversion Tracking-shall mean the system that is provided by a search engine, or separate application, to inform an advertiser of which (i) keyword string(s) or (ii) keyword string(s) plus answers to subsequent survey questions generated in response to submitting the keyword string to the search engine yield a successful response, as defined by the advertiser.

Keyword—shall mean any word (or portion of a word) that is (or was) typed in a search engine to generate a search or searches.

Keyword String—shall mean a group of one or more keywords

Product—any goods, services, information, or items, whether tangible or intangible, that may be made available to a searcher by an advertiser, whether offered for sale, barter, loan, or free of charge.

Search Engine—shall mean a system such as Google or Yahoo that receives a search query comprised of a keyword or keyword string from a searcher and provides website listings to the searcher based on the submitted search query.

Searcher—shall mean an individual or computer program that submits a search query to a search engine.

Survey question or questionnaire—shall mean a request for information from a searcher where the request has been triggered by a search query submitted to a search engine by the searcher. A survey question or questionnaire need not be phrased in the form of a question.

Success Criteria—shall mean any criteria defined by the advertiser indicating that a searcher has successfully performed an activity. These activities could be, but are not limited to (i) purchasing something from the advertiser's website (ii) filling out a survey on the advertiser's website (iii) seeing the advertiser's advertisement or (iv) going to the advertiser's or another sponsored link or website.

End User shall mean any person including a person benefiting from, making use of or practicing the various disclosed embodiments of the invention or any variants thereof including any user of a web browser such as Internet Explorer who enters search phrases into a search engine such as Google™ or a website such as Santafe.org.

Central System—may be one or more of a computing device or server or group of servers, which may or may not be located in a common facility and which may or may not be remote to an End User that manages the content and display of surveys.

Survey—A group of questions, check boxes, drop down menus, date selectors, and any other method of entering personal preference data into an online form in response to a keyword being entered into a search engine or website. When a survey is submitted, advertisements are displayed that are customized based on the survey.

Clone—An identical or nearly identical or modified copy of any one or more of an individual or group of a computer programs or a search program or a survey program or other software application embedded into or otherwise interfaced with or to any one or more of, including, but not limited to, for example a website or other computing system.

Service Provider—any entity that provides services that can be advertised in the results of a filled out survey.

Vendor entity that wishes to have advertisements placed in survey results

Vendor Website—the website owned by a vendor, links for these websites can be placed in the advertisements of survey results.

Local Website—a website that has a high natural or organic placement for a particular keyword or group of keyword phrases.

Click Through Rate—The percentage of times an end user or other individual chooses a link to a displayed website, marketing offer, advertisement, survey question(s), e.g., the number of displayed links divided by the number of end users that click on said links.

End User Historical Search Profile—A database or other repository of information that contains information about an End User's previous search activity, website preferences, actions, click through rate, buying preferences, demographics (e.g., any one or more of an end user's annual income, address, buying habits, age, sex, race, or other information particular to that end user.)

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

Moreover, the term “determining” does not imply that mathematical processing must be performed, does not imply that numerical methods must be used, and does not imply that an algorithm or process is used.

Furthermore, the term “determining” does not imply that any particular device must be used. For example, a computer need not necessarily perform the determining.

Process—any process, algorithm, method or the like, unless expressly specified otherwise. Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

An embodiment, embodiment, embodiments, the embodiment, the embodiments, one or more embodiments, some embodiments, certain embodiments, one embodiment, another embodiment and the like—means “one or more (but not all) embodiments of the disclosed invention(s)”, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise.

Variation, as in “variation of an invention”—means an embodiment of the invention, unless expressly specified otherwise.

“Including”, “comprising” and variations thereof—mean “including but not limited to”, unless expressly specified otherwise.

“Consisting of” and variations thereof—mean “including and limited to”, unless expressly specified otherwise.

“A,” “an” and “the”—mean “one or more”, unless expressly specified otherwise.

Plurality—means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things)—means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies does not establish specific further limitations of the claim or otherwise restrict the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms means “that is”, and thus limits the term or phrase it explains. For example, in the sentence “the computer sends data (i.e., instructions) over the Internet”, the term “i.e.” explains that “instructions” are the “data” that the computer sends over the Internet.

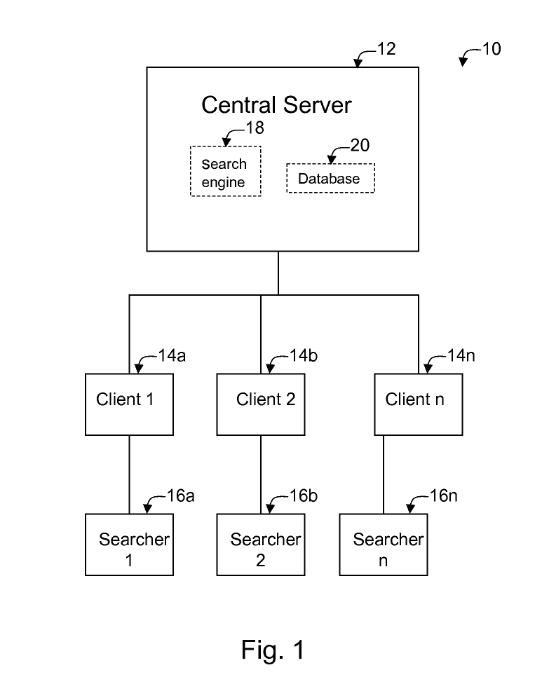

Turning now to FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 18 may be located, collectively, or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth␣, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

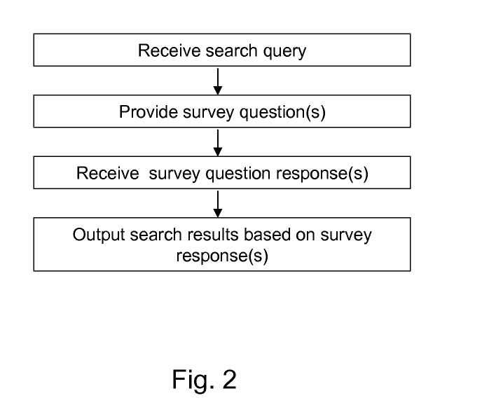

Turning now to FIG. 2, a method according to one embodiment of the present disclosure is provided. According to this embodiment, when a search query is received from a searcher, one or more survey questions are sent to the searcher. The answers provided by the searcher to these survey questions are then used to refine the search results that are provided to the searcher. For example, a searcher may input a search query of “GPS unit.” In response, the searcher may then be offered a survey question such as, “Are you interested in a Car GPS, a Boat GPS, or an Airplane GPS?” The searcher's response could then be used to provide search results that correspond to the searcher's interests.

It will be readily understood that a survey question may be offered alone or as one of a plurality of questions. If a plurality of questions are offered, the may be offered simultaneously, sequentially, or in sequential groups. For example, if a searcher responds affirmatively to the above question regarding Car, Boat, and Airplane GPS systems, the search may be provided with a second question clarifying which of these he is interested in. If a searcher responds by indicating interest in a Car GPS, the searcher could be asked an additional follow-on question such as, “Are you interested in purchasing a Car GPS unit?” If the searcher responds positively, additional survey questions could be asked and/or the searcher could then be directed towards advertising for Car GPS units.

Alternatively, or additionally, the searcher may be provided with an initial list of questions such as:
Are you interested in purchasing a GPS system?
Are you interested in purchasing accessories for a GPS system?
Are you interested in maintaining a GPS system that you currently own?
Are you interested in learning how a GPS system works?

The searcher may then be provided with links for appropriate websites or asked additional follow-on questions depending upon which question the searcher responds to, if any.

According to one embodiment, a survey question may be offered prior to search results being provided to the searcher. Alternatively, a survey question and the search results that would be generated based solely on the original search query could be provided to the searcher simultaneously. In such a case, the survey question and search results may be provided to the user in such a way that the user can easily distinguish between the survey question and the search results. For example, the survey question may be provided in a separate part of a web browser window or in a separate browser window.

According to another embodiment, once the searcher provides an answer to the survey question, new search results can be generated and displayed. According to some embodiments, new search results may be generated dynamically, such that search results, surveys, products and/or other actions may be presented to the searcher in real time as the searcher types search queries or answers into any portion of the search engine or survey questionnaire. As the searcher types search words, strings or answers or any portions thereof, the system can provide “interim” results.

It will be understood that the survey questions may be offered by the search engine. Alternatively, the survey questions may be offered by a third party that monitors queries to the search engine and then provides questions to the searcher, either directly, or indirectly, e.g. via the search engine. Accordingly, for the purposes of simplicity and clarity, the present disclosure may make reference to a “survey program.” It will be understood that the survey program may be an integral part of the search engine or may be a separate program, or group of programs, configured to work with one or more search engines. Moreover, the survey program may be operated by the entity that operates the search engine, or operated by a third party that is or is not associated with the search engine.

According to one embodiment, the present disclosure provides search methods and systems related to keyword advertising. According to one method of keyword advertising, a searcher types a keyword or search string into a search engine. Based on the keyword or search string entered, a list of advertisements is shown to the user. A certain percentage of searchers will typically select or “click on” an advertisement of interest, and are then directed to a website providing additional information related to the advertisement. According to some methods, the advertiser may pay the search engine provider some amount of compensation each time a searcher clicks on the advertisement.

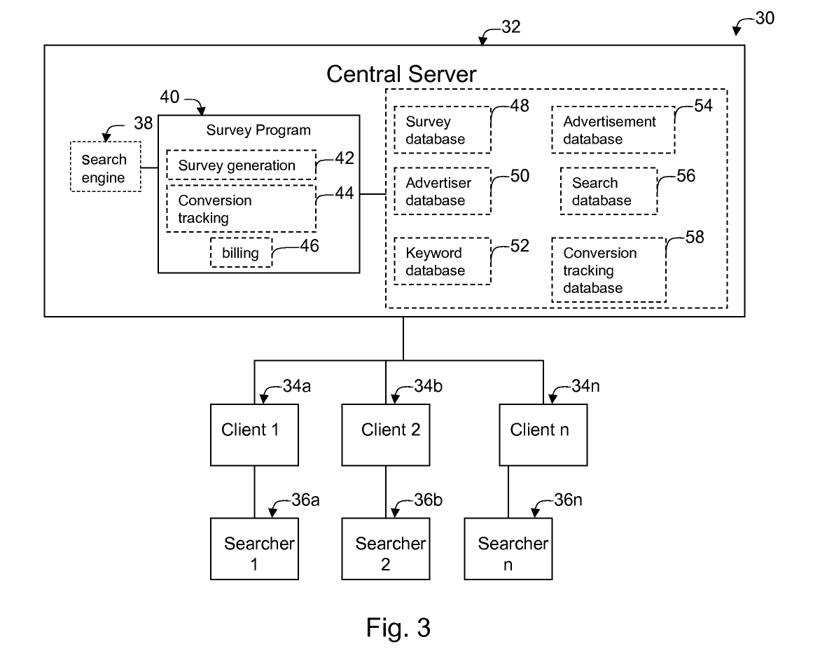

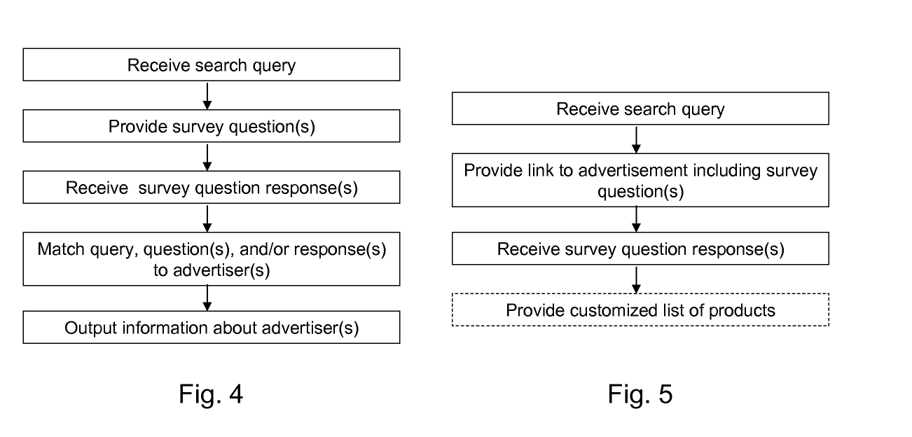

FIG. 3 provides a block diagram of a system 30 configured provide survey based qualification of keyword advertising. As shown in FIG. 4, a central server 32 is in electronic communication with one or more client computers 34, through which one or more searchers 36 are able to access programs such as search engine 38 and survey program 40, located on central server 32. It will be appreciated that while search engine 38 and survey program 40 are shown as being hosted by a single central server 32, they may actually be hosted on the same or different computers which may or may not be servers. Moreover, as explained above, survey program 40 may be an integrated part of search engine 38 or a separate program operated by the same or a different entity as the search engine. Survey program 40 may include multiple optional programs such as a survey generation program 42, conversion tracking program 44 and advertising billing program 46. Moreover, survey program 40 may be electronic communication with a number of databases such as, for example, survey database 48, advertiser database 50, advertiser keyword database 52, advertisement database 54, search database 56, and conversion tracking database and 58. While the databases are shown as being hosted by central server 32, it will be appreciated that one, some, or all of the databases may be hosted on another server, or hosted by other computers.

According to an embodiment, system 30 may be configured to allow an advertiser to select a keyword (or keywords) with which he would like to associate an advertisement. It will be understood that an advertisement in this sense may take the form of or include a link to the advertiser's website or a third party website displaying the advertiser's product. Moreover, an advertisement may take any other suitable form, as described in greater detail throughout the present disclosure. According to some embodiments, the advertiser may select the keyword(s) by purchasing the right to associate his advertisement with the keyword(s). The advertiser may select and/or purchase the keyword(s) for their exclusive or non-exclusive use (i.e. other advertisers may or may not be allowed to associate their advertisements with the selected keyword(s)).

Moreover, the advertiser may want to further qualify to which searchers he would like his advertisement shown. Accordingly, he may also select one or more survey questions that he would like asked before his advertisement is shown to a particular searcher. According to some embodiments he may pay for the right to have a given question asked to a searcher who has submitted a search query including the selected keyword. These questions may be submitted by the advertiser, suggested or provided by the operator of the survey program, or suggested or provided by a third party. Like keywords, questions may be selected and/or purchased exclusively or non-exclusively.

If an advertiser selects questions with which he would like his advertisement associated, he may also want to select answers which would either trigger showing his advertisement or not showing his advertisement. According to some embodiments he may pay for the right to have his advertisement associated or not associated with a given answer or set of answers. Answers may be selected and/or purchased exclusively or non-exclusively.

As a further embodiment, the advertiser may also specify additional criteria which, must be satisfied in order for a particular advertisement to be shown. For example, the advertiser may wish to associate a particular discount offer to searchers who fulfill certain conditions. These additional criteria may be suggested by the advertiser, the survey program provider, or a third party. Moreover, the additional criteria may be purchased or selected for the advertiser's exclusive or non-exclusive use.

According to some embodiments the advertiser may alternatively or additionally pay the operator of the survey program each time his selected question is provided to a searcher, each time a selected answer is provided by a searcher, each time his advertisement is shown to the searcher, each time a searcher access the advertiser's website (or another party's website displaying the advertiser's product) via the survey program, each time a searcher meets the advertiser's success criteria, at any other suitable point, or any combination of the above.

It will be understood that the advertiser may be allowed to limit or otherwise exercise control over his financial obligations to the survey program operator by selecting the specific criteria under which his advertisement is to be shown to a searcher. Moreover, according to some embodiments, the advertiser may further be allowed to specify a cap or not-to-exceed limit for the amount to be paid to the survey program operator. This limit may be provided for a given time period, such as a not to exceed daily, weekly, monthly, and/or yearly maximum. According to some embodiments, once the not-to-exceed limit is reached, the survey program may or may not provide the advertiser's advertisement to searchers who fulfill the advertiser's criteria.

As a non-limiting example, an advertiser who is a Hyundai dealer in Norwalk, Connecticut may purchase or otherwise select the keyword “Santa Fe.” The dealer may further purchase or otherwise select the questions “Are you interested in purchasing a vehicle?” and “Where are you interested in purchasing the vehicle.” The dealer may further purchase or otherwise select the answers “Yes” and “Connecticut or Norwalk, Conn.,” respectively. The dealer may further specify that a searcher who has visited other car dealer websites may be provided with an advertisement offering a special discount, such as a $100 gift certificate to a local retailer, if the searcher signs up for a test drive via the advertiser's website.

Accordingly, the Hyundai dealer may have paid a one time fee to the survey program operator for the right to associate his advertising with the keyword “Santa Fe.” He may have also paid a one time fee for the right to associate his advertising with the questions “Are you interested in purchasing a vehicle?” and “Where are you interested in purchasing the vehicle.” He may then pay a given amount to the survey program operator each time a searcher returns the answers “Yes” and “Connecticut or Norwalk, Conn.,” and his advertisement is shown. Of course it will be understood that various other payment schemes are possible.

Returning to FIG. 3, survey database 48 may be used to maintain and track survey questions. The survey database may maintain and associate data such as survey ID, survey questions, survey answers, keyword string, survey question sequence, survey question conditions and the like. For example, in the car dealer example above, the survey database would be used to associate the Hyundai dealer with the keyword “Santa Fe,” the question “Are you interested in purchasing a vehicle?” with the answer “Yes” the question “Where are you interested in purchasing the vehicle?” with the answers “Connecticut” and “Norwalk Conn.” Moreover, the database may also indicate that the question “Where are you interested in purchasing the vehicle” should only be asked if the searcher has answered “Yes” to the question, “Are you interested in purchasing a vehicle.”

Advertiser database 50 may be used to maintain and track information regarding advertisers who use the survey program's services. The advertiser database may maintain and associate data such as advertiser ID, advertiser personal information, advertiser billing information, a maximum daily spending limit, a maximum monthly spending limit, and the like.

Accordingly, in the Hyundai dealer example above, the advertiser database may include information about the Hyundai dealer such as contact name, address, credit card number, and not to exceed limits on advertiser spending, etc. Each advertiser may be assigned specific identification indicia (e.g. numbers, letter, symbols, or combinations thereof) that is used by the system.

Advertiser keyword database 52 may be used to associate selected keywords with advertisers and information regarding the association. The advertiser keyword database may maintain and associate data such as keyword ID, keyword name, survey question, survey answer, survey question conditions, maximum price to ask question in response to keyword string, advertiser ID, maximum price per click, maximum price per email, maximum price per displayed advertisement, and the like.

Accordingly, in the Hyundai dealer example above, the advertiser keyword database may associate the keyword “Santa Fe” with the questions provided above. Moreover, the database may further indicate that the dealer is willing to pay, at most, $0.10 to have the question “Are you interested in buying a car?” asked and $0.25 to have the question “Where do you want to buy the car?” asked. (It should be noted that according to some embodiments, the second question will only be asked if the first question is answered affirmatively.) The database may further indicate that the dealer is willing to pay a maximum of $0.25 each time an email including a link to his website is sent to a searcher, $0.25 each time his advertisement is displayed to a searcher and a maximum of $0.50 each time a searcher accesses his website via the survey program's services. The database may further indicate that the dealer is willing to pay a maximum of $5 each time a first success criteria is met, e.g. the searcher schedules a test drive through the searcher's website after accessing the website via the survey program and a maximum of $100 each time a second success criteria is met, e.g. the searcher purchases a car from the dealer.

Moreover, according to some embodiments, these maximum amounts may be altered, for example by the advertiser or the survey program, over time in accordance with the level of success, or lack thereof, a given survey question(s)-keyword combination brings to the advertiser.

Advertisement database 54 may be used to maintain and track the advertisements that are provided by the survey program in response to searcher queries. The advertisement database may maintain and associate data such as advertisement ID, advertisement text, advertisement website address, advertisement conditions, advertisement triggering keywords, advertisement triggering survey questions, advertisement triggering survey answers, advertisement triggering conditions, discount offers, discount offer triggering conditions, and the like.

Accordingly, in the Hyundai example above, the dealer may provide the survey program with multiple advertisements. For example, the dealer may provide the survey program with a first advertisement simply providing information about the vehicle and the dealership, a second advertisement offering a $100 gift certificate if the searcher schedules a test drive via the website (and then subsequently shows up for the test drive), and a third advertisement offering $500 cash back to a searcher who comes to the dealership and purchases a vehicle that day. The advertisement database may further include information determining which specific keywords, questions, answers, and or other conditions would trigger each of the advertisements to be provided to the searcher. For example, a searcher who enters a search query of “Santa Fe” and “test drive” and answers affirmatively that he is interested in purchasing a vehicle and is in Norwalk, Conn., may be directed towards the advertisement offering $500 cash back, since he appears to have a clear interest in purchasing the car. Alternatively or additionally, a searcher who has accessed the advertiser's website multiple times within a given time period, say three times in the last two weeks, may be directed towards the second advertisement offering the $100 gift certificate as an extra inducement to come to the dealership.

Search database 56 may be used to track the search queries that triggered the survey program's services and the subsequent behavior of the searcher. The search database may maintain and associate data such as search ID, keyword string, survey generated, survey answers, advertisements displayed, advertisements selected, conversion data, transaction data, and the like.

Returning to the Hyundai dealer example, the dealer may agree to a condition that he will increase his payments by a given amount (e.g. $0.10, 25%, or the like), for each keyword, question, and/or answer that can be shown to be directly linked to a certain number of vehicles sold within a given time period (e.g. 5 vehicles sold in a month). The search database may be used to track this information so the survey program can determine whether the Hyundai dealer's payments should be increased and by how much.

Conversion tracking database 58 may be used to track success rates, as described in greater detail below. The conversion tracking database may maintain and associate data such as keyword ID, advertiser ID, time period and date, # of times a keyword has been entered, # of times an appropriate survey answer was received, # of keywords with appropriate answers who selected advertisement, # of keywords with appropriate answers who selected advertisement that also performed success criteria, # of keywords with appropriate answers who selected advertisements that also made a purchase from the specified advertiser website, and the like.

Again, in the Hyundai dealer example, the Hyundai dealer may be interested in determining which keyword, question and answer combinations are successful and which are not. He may use this information to change his keyword, question, and answer preferences, to determine whether or not and how much to pay for each keyword, question and/or answer, and/or for any other purpose. The conversion tracking database may be used to provide this information to the advertiser, the survey program operator, and or any other interested party.

It will be appreciated that the above databases and database descriptions are provided as non-limiting examples only and that the actual architecture of the system will be largely dependant on the actual system and methods being implemented and could include some, none, or all of the above databases and information in combination with any other databases and information, as necessary or desired.

FIG. 4 provides a method of survey-based qualification of keyword advertising. According to the depicted embodiment, a search engine receives a search query from a searcher. A survey question is then provided to the searcher. Based on the searcher's response to the survey question, one or more advertisements are then provided to the searcher.

According to some embodiments, the advertiser may pay the survey program provider some amount of compensation each time a searcher clicks on the advertiser's advertisement. Alternatively, or additionally, and as will be explained in greater detail below, the advertiser may pay the survey program provider upon the completion of any particular milestone in the process. For example, and without limitation, the advertiser may pay the survey program provider to use survey questions submitted by the advertiser, each time a searcher receives a survey question submitted or selected by the advertiser, each time a searcher answers a survey question submitted or selected by the advertiser, each time a searcher answers a question related to the advertiser's good or services, each time a searcher gives a specific answer in response to a survey question, when a searcher purchases a service or product after accessing the advertiser's web site via the survey program's services, to appear as part of any interim results, for information gathered by the survey program, or any combination thereof.

It will be appreciated that survey questions may be generated in any suitable method and by any suitable party. Accordingly, the survey program may be provided with a list of questions and the means to match certain keywords found in search queries to certain questions. For example, the survey program may have access to a survey question database containing any number of questions. Each question may be associated with at least one keyword. Accordingly, when a search engine receives a search query, the survey program may search the survey question database for any matched survey questions, i.e. survey questions that are associated with the keyword(s) appearing in the search query. If a matched survey question is found, the survey program may submit the matched question to the searcher. If more than one matched survey question is found, the survey program may submit one, some, or all of the matched questions to the searcher.

Questions may be developed by any entity or combination of entities capable of doing so including, without limitation, the survey program operators, the advertisers, or a third party consultant hired by the survey program operators or the advertisers. The operators of the survey program may develop questions based on a variety of factors, including, but not limited to, their client lists, past performance, known interests from searchers, etc. For example, a search engine which advertises itself as being a top search engine for car buyers may develop questions related to the make, model, and options of the cars that are offered by advertisers who have paid to use the search engine's services. Alternatively or additionally, advertisers may provide a list of questions they would like submitted to searchers who use a specific keyword or phrase in their search queries or who fall into some other identifiable category.

As a further alternative, questions may be automatically generated with or without human input by a computer program. For example, a survey (or other) program may automatically generate survey questions “on the fly” based on the appearance of one or more keywords in a search query. For example, the survey program could be configured to automatically respond to any query including a known commodity with the question “Are you interested in purchasing a (insert name of known commodity).” Alternatively, more sophisticated methods for automatically generating survey questions could be employed. Methods for automatically generating search questions based on patterns of speech are described, for example, in Allan and Raghavan, “Using Part-of-speech Patterns to Reduce Query Ambiguity” In Proceedings of the ACM Conference in Information Retrieval (SIGIR), pages 307-314 (2002), which is hereby incorporated by reference in its entirety for all purposes.

As stated above, advertisers may pay the survey program provider to use those questions and/or to match certain keywords to specific questions (regardless of who developed the question) and/or advertisements. Alternatively, or additionally, advertisers may bid for the right to have certain keywords matched to their questions and/or advertisements.

It will be appreciated that in many cases, a given search query may be associated with multiple survey questions. In such a case, the survey program could provide all or a subset of the matched questions to the searcher. If the survey program is configured to provide a subset of the matched questions to the searcher, the survey program could be configured to select the subset of matched questions based on any number of desired factors. For example, the matched questions could be prioritized based on which questions have proven to be statistically more successful in the past, which questions advertisers have paid, or bid, more for, which questions have previously been answered by this or another searcher, etc. Alternatively, the survey program could be instructed to select one or more matched questions at random. As a further alternative, the survey program could be configured to select a set of matched questions conforming to a variety of factors. For example, the survey program could be configured to select one question with a known high success rate, one question from a high-paying advertiser, and one question at random. It will be appreciated that numerous other variations and combinations are possible and that all such variations and combinations are contemplated by the present disclosure.

As a further embodiment, the survey program may only ask a single or a few questions from each user, but, aggregate the information across a large number of users. The survey program can then learn what questions matter and don‘t matter over time. Accordingly, the survey program could select a few questions from a very large survey, so that, with use, only the important questions are asked, but all questions are answered by a large population. Using traditional statistical methods, the survey program could operate as if every user is answering every question. Furthermore, once the survey program determines which questions apply to which search strings, irrelevant questions can be eliminated from the survey question pool, making those question(s) asked much more likely to yield desirable results.

According to another embodiment, questions may be generated based on stored answers to previously presented questions. For example, the survey program may be configured to generate and output a list of questions in response to a keyword string and then receive and store the responses to the questions. The survey program could then be configured to generate survey questions based on previously stored answers. As a non-limiting specific example, the survey program may be initially configured to respond to a search query containing the keyword “Santa Fe” with the questions “Are you interested in purchasing a vehicle?” and “Are you interested in Santa Fe, N.Mex.?” Searchers who indicate that they are interested in Santa Fe, N.Mex. may be asked additional questions regarding their interest, e.g. in a vacation, in skiing, in art galleries, etc. The survey program may determine, over a period of time, that a large percentage of searchers who input the keyword “Santa Fe” are interested in Santa Fe ski vacations. Thus, instead of requiring these searchers to answer a series of questions, the search program (or advertiser) may determine that it is expedient to include the question, “Are you interested in a Santa Fe ski vacation?” as one of the initial question provided in response to the search query “Santa Fe.”

Moreover, the survey program may generate a list or survey questions that are to be provided in a particular order, depending upon the answers that are provided by the searcher. Accordingly, according to another embodiment, the present disclosure provides a method for generating and providing survey questions. The method includes generating and outputting a list of survey questions in a particular order and with a particular sequence. The method further includes receiving and storing responses to the questions. The method still further includes generating subsequent survey questions based on previously stored answers.

According to another embodiment, the survey program may be configured to track success rates for different survey questions. A success may be a searcher clicking on an advertisement, purchasing an item, providing information to an advertiser, or any other behavior identified as successful by the advertiser. The survey program may be configured to identify when and how often a particular question leads to a success. As such, the survey program and advertisers may be able to identify those questions that more accurately predict whether a searcher is interested in their products and services. Accordingly, advertisers may be willing to pay increased prices for specific questions or keywords which are known to have a high success rate for their business.

Moreover, in an embodiment where the survey program provider receives payment when a searcher subsequently makes a purchase from the advertiser website, the survey program can manage the system of questions to refine a search so that a searcher is directed to an advertiser's website with the greatest likelihood that the searcher will purchase something from that website. The survey program may use a manual or Al tool that tracks the survey questions and corresponding answers that yield the greatest or most probable likelihood that the searcher will make a purchase from the advertiser website. The survey program can track which searchers make a purchase from an advertiser's website once the searcher has selected an advertiser's advertisement. When a purchase is made from the advertiser's website, the advertiser account may be charged a fee by the survey program.

According to one embodiment, an advertiser can select or enter a certain x number of questions and corresponding acceptable answers to ask in response to a keyword string submitted by a searcher. The central system can randomly or systematically ask the questions in response to subsequent keyword strings submitted by later searchers. A conversion tracking system can track which keyword strings plus which answered questions (and in which order) yield the greatest percentage of customer conversions. For example, the keyword string “gps unit” combined with an answer “yes” to a subsequent question in a survey of “are you interested in a gps for your car today?” could yield the highest percentage of searchers who subsequently click on an advertisement and make a purchase from the advertiser's website.

Accordingly, the present disclosure provides a method for providing a limited number of questions in response to a search query including a specific keyword string. The method may include, for example, receiving a search query including keyword that has been associated with an advertiser, retrieving a list of potential survey questions to output in response to the keyword string, prioritizing the list of questions based on the price the advertiser is willing to pay for each question (or some other factor), determining a maximum number of questions to ask the searcher, and outputting the maximum number of questions in order of priority. The maximum number of questions to be output may be determined, for example, by the maximum amount of money the advertiser is willing to pay, by a predetermined number set by the advertiser or the survey program, or by other factors.

An example of another factor that could be used to prioritize the list of questions to ask the searcher is the answers that have been previously, or are usually, received from previous survey questions generated in response to the same keyword string.

Conversion tracking may include, without limitation, the keyword string input by the searcher, the survey question asked, the searcher's answer, and the searcher's subsequent behavior (e.g. which sites were visited, the order of the sites visited, whether goods or services were purchased, whether the searcher requested any additional information, etc.) Using conversion tracking the survey program may also identify the order of questions asked. In this way a survey question tree structure could be set up initially, and then dynamically rearranged so that conversion probabilities are maximized.

Moreover, any of the above-described embodiments can be enhanced by adding additional search enhancement options to them such as tracking searcher demographic and/or historical search behaviors. This information can then be used to modify surveys based on the searcher profile and search history that is stored with the central server.

As a further embodiment, the survey program could provide the information gathered from the searcher's survey answers to one or more advertisers. Advertisers could use this information in any number of ways including, for example, to develop more focused directed-advertising campaigns, to create lists of potential customers, to develop their goods and services etc. The information could be provided to the advertiser in any number of ways. For example, each completed survey that triggers the advertiser's advertisement could be sent to the advertiser. If the survey contains contact information regarding the searcher, the advertiser could use this information to contact the searcher directly. Alternatively or additionally, completed surveys that lead to a successful transaction could be forwarded to the advertiser. As a further alternative, the survey program could be configured to compile statistical data regarding searchers, searcher behavior, keywords, success rates, and the like and forward this information, with or without personal information related to the searcher(s) to the advertiser. According to a further aspect of this embodiment, advertisers could pay a fee for this information. Various fee schedules could be adopted depending on various factors such as, without limitation, the type and amount of information collected by the survey program, the type and amount of information provided to the advertiser, and the rate or likelihood of a successful transaction based on the information provided by the survey program.

With questions that are known to yield a higher rate of success, advertisers may be more inclined to pay more to be associated with these questions. Accordingly, in one embodiment, the survey program may provide differential pricing schemes for different questions or keywords. This differential pricing scheme may be based on a question's or keyword's known (or expected) rate of success or other factors. Moreover, the survey program may be further configured to receive bids, auction-style or otherwise, from advertisers desirous of associating their advertisements with specific questions or keywords.

According to another embodiment, advertisers could pay to have a question that they want to ask to be included in a list of no more than x questions that are compiled into a survey and output to a searcher in response to submitting a keyword string for search. Moreover, advertisers could specify the specific answer or answers to the questions that would serve as a trigger to provide the searcher with a link to the advertiser's advertisement and/or website. Depending on the pricing scheme, this could be done to reduce the advertiser's potential costs or for other reasons.

It will be appreciated that numerous methods of selecting survey questions may be used and that any suitable method may be used. Furthermore, the suitability of a method may be dependant upon the intents and purposes of the particular survey program and/or advertisers associated with the particular survey program. For example, a survey program that receives payment from an advertiser every time that advertiser's advertisement is clicked may be more inclined to preferentially display questions provided by or related to an advertiser who pays more per click.

As stated above, a survey question may be provided prior to or simultaneous with the delivery of search results by the search engine. It will be appreciated that more than one survey question may be given to a user at one time and that questions may be provided and answers received in any suitable format. For example, the question above, “Are you interested in a Car GPS, Boat GPS, or Airplane GPS?” may be provided as a single question with a yes or nor response button. Alternatively the same question may provide an open ended answer blank in which the searcher may type any response. Alternatively, the question may be provided with check boxes, selectable radio buttons, or the like, which allow the searcher to select one or more responses. Furthermore, the same information may be requested in the form of three separate questions, e.g.: “Are you interested in a Car GPS? Are you interested in a Boat GPS? Are you interested in an Airplane GPS?” Moreover these questions may be presented in a format other than as a question. For example, “Please choose the option listed below that most closely resembles your interests . . . .” Thus it will be understood that questions and answers may be provided in a myriad of formats that are too numerous to list in any detail and that any suitable format is contemplated by the present disclosure.

Once a response has been given to a survey question, additional follow on questions may be given. Such questions may be provided for a variety of reasons, including, without limitation, to further narrow the search results to be provided to the searcher or to gather additional information about the searcher.

For example, a searcher who has indicated interest in purchasing a car GPS system may be asked, “Are you interested in purchasing a car GPS system today.” If the searcher responds positively, he may be provided with a link to a web page advertising a special price that is good for “today only.”

Alternatively or additionally, a searcher who has indicated interest in purchasing a car GPS system may be asked to provide his address, phone number, email address and/or other contact information. This information may be retained by the survey program and/or provided to one or more advertisers, for example, so that representatives from companies offering GPS systems may contact the searcher to answer questions, provide additional information, transact a sale, etc.

According to another embodiment, the survey program may be configured to generate a list of advertisers in response to the search query and survey question answers provided by the searcher. The list of advertisers could be delivered to the searcher using any suitable means. Examples of ways in which the list of advertisers could be provided to the searcher include, but are not limited to, as part of the search engine's search results, on the same page, but separate from, the search engine's search results, as (or part of) a third party website, as (or part of) a pop-up window, in an email or text message sent to the searcher, in an automated phone call to the searcher and/or via regular mail routes. The list could provide contact information and/or, if in electronic form, be hyperlinked to the advertiser's websites. If in a form capable of supporting such features, the list could include text, audio and/or video.

According to yet another embodiment, the survey answers could be sent to a number of relevant advertisers who could then market directly to the customer. In this embodiment, the survey would include personal information provided by the searcher. For instance, the searcher could provide his or her email or mailing address as part of the survey answers, and advertisers could use that information to correspond with the searcher.

Accordingly, the present disclosure provides a method according to an embodiment for providing the survey answers to relevant advertisers. The method may include providing a survey to a searcher in response to a search query, receiving an answer to the survey, determining relevant advertisers based on the survey answer, and outputting the relevant survey answers to the relevant advertisers. Accordingly, advertisers could indicate which keywords, questions, and answers they want associated with their products and then pay to have information about searchers who have provided the appropriate keywords and question answers, forwarded to them.

FIG. 5 provides yet another method according to an embodiment of the present disclosure. According to this embodiment a search engine receives a search query from a searcher. In response to the search query, the search engine provides the searcher with links to advertisements related to keywords or phrases in the search query. Upon selecting one of the advertisements, the searcher is directed to a website offering survey questions. According to a further embodiment, responses to the survey questions are then used to provide a customized list of products, services, resources or other information in which the searcher has an interest.

As a non-limiting example, a searcher interested in planning a vacation to Santa Fe, N.Mex. can enter the terms “Santa Fe vacation” into a search engine such as the Yahoo® Search engine provided by Yahoo, Inc. (Santa Clara, Calif.). Included in the Yahoo search results is a short list of sponsored links. One of these sponsored links could advertise a trip planner to help vacationers plan their trips. A searcher could click on this link and be directed to a website providing a survey that allows the searcher to indicate various activities of interest, accommodation preferences, and the like. Upon completing the survey, the searcher could be provided with a personalized list of advertisements from providers or goods and services related to the searcher's indicated interests as well as other relevant information. The personalized list could be provided to the searcher using any known means including, for example, as part of a web page, in an email, in the mail, as a text message, on the phone as a recorded message, via a live phone operator, etc. In this embodiment, advertisers may pay to have their advertisements (and/or questions) associated with the survey program's website.

As a further embodiment, portions of the survey could be pre-selected for the user based on the terms included in the user's keyword search. For example, a user may provide a search query for “destination wedding.” The survey program may be configured to ask “Are you interested in a destination wedding” for any search query including the term “wedding.” In this case, the survey program may be configured to provide this question (with or without other questions) with a pre-selected answer (e.g. a corresponding radio button is already selected, a drop-down menu is already selected to “yes”, etc.) because the term “destination wedding” appeared in the search query.

According to yet another embodiment, advertisers could provide special incentives, discounts, promotions or the like to searchers who purchase or otherwise complete a successful transaction while or after using the survey program's features. For example, advertisers could pay to have their product listed for purchase with a discount or other promotion valid only at the time of the search. Such promotions could be limited, for example, by time, to that specific search, etc. In this embodiment, a promotional offer may be made to the searcher based on the keyword string he enters and his responses to the subsequent questions generated by the survey program on behalf of the advertiser. Accordingly, the advertiser may specify the specific answers to the survey questions that a searcher would need to answer in order to be able to view and/or take advantage of the promotional offer. The advertiser could further specify a promotional offer such as a dollar or percent discount off of the purchase total that will be provided to the searcher who clicks on the advertisement.

Accordingly, another method according to one embodiment of the present disclosure provides for providing a survey in response to a search query, determining if a promotion is available based on the survey answer(s), outputting the promotion if available, receiving an indication that a purchase has been made, applying the promotion to the purchase, and storing information related to the usage of the promotion.

According to one method of implementing this embodiment, when a searcher makes a purchase from a website that he has accessed via an advertisement provided by the survey program, the system may check to see if a discount is available based on the advertisement that was clicked by the searcher. If a discount is available, the discount may be applied to the purchase total while the searcher is checking out. The discount can be applied to the searcher's transaction based on conditions such as whether or not a particular SKU or product is in the transaction.

As a specific, non-limiting example, a searcher who enters “GPS Unit” and responds affirmatively to the question “Are you interested in buying a GPS unit today?” could be shown an advertisement generated by the survey program on behalf of the advertiser that says “Buy a GPS unit today and receive 20% off. Just click on this advertisement to receive your discount.” If the searcher clicks on the advertisement, he is directed to the advertiser's website. If he purchases the GPS unit immediately, the discount may be automatically applied to the transaction after confirming his eligibility.

Alternatively, a survey question need not necessarily be provided before displaying an advertisement with a discount. In this embodiment, the search engine could automatically generate an advertisement displaying the promotion in response to a search query including specific keywords or phrases. For example, a searcher typing “Garmin 2610” into a search engine could see an advertisement that says: “Purchase a Garmin 2610 now and receive a free battery charger.” If the searcher clicks on the search engine-provided advertisement, the searcher is redirected to the advertiser's website. If the searcher initiates a purchase of the Garmin 2610, a program could determine the searcher's eligibility for the promotional item by determining if he accessed the advertiser's website via the search engine-provided advertisement, as well as any other advertiser- or search engine-specified eligibility factors, and the additional item could be added to the transaction.

According to yet another embodiment, the advertiser could select the keyword string, question(s) and answer(s) they want associating with their advertising. In this embodiment, a searcher would have to input the advertiser-selected keyword, receive the advertiser-selected survey question (or questions), and respond in the way previously indicated by the advertiser before being directed to the advertiser's website. For example, a searcher may submit the search query “Santa Fe vacation” and receive the following questions from the survey program:
i. Are you interested in planning a vacation to Santa Fe, N. Mex.?
ii. What type of accommodation are you interested in?
iii. Please tell us the dates of your trip.

A searcher who responds by saying that he is interested in planning a vacation to Santa Fe, N.Mex., that he is interested in staying at a Bed and Breakfast and that he would like to be there between December 30 and January 2, might be directed to a specific Bed and Breakfast website offering special holiday rates or inviting them to a New Year's Eve celebration. Conversely, a searcher who indicates that he is interested in planning a vacation to Santa Fe, N.Mex., that he is interested in staying at a Bed and Breakfast and that he would like to be there between April 1 and April 7, might be outside of the parameters specified by the first Bed and Breakfast and would therefore be provided with different search results.

In this way, a Bed and Breakfast with lots of openings for one period of time but that is completely booked during another period, can set up the survey program so that it will only be changed for searchers who are interested in booking rooms during the time period when the Bed and Breakfast has availability.

Accordingly, another method according to one embodiment of the present disclosure provides for receiving a survey answer in response to a survey generated by a search query, outputting a list of products available for purchase, and receiving an indication that a product was purchased. The method may further provide for determining a billing amount, and billing the advertiser the billing amount.

In an alternate embodiment, a product or list of products can be offered for sale and purchased by a searcher in response to the combination of a keyword string and a completed survey. In this embodiment, a list of products would be retrieved from a database in response to the submitted keyword and survey answers. The list of products would be made available to the searcher on a website. The customer could select one of the products and place it into a virtual shopping cart for purchase. Advertisers could pay to have their product listed for purchase.

According to another embodiment, the searcher can place his search request by entering his request via a keyboard into a web browser, speaking his request into an IVRU, or using any other means of transmitting a search query to a search engine. For example, a customer searching for a place to eat while he is driving down the road may enter a request for nearby restaurants into his GPS unit. The GPS unit may output a survey to further specify what types of food the searcher is interested in eating. The searcher may further refine his search request by indicating, for example, that he wants to eat at a table dining restaurant that serves Japanese food. The searcher may then be provided with information about a local Japanese restaurant that has paid the browser to have their advertisement, along with directions to the restaurant output to the searcher.

Accordingly, another method according to one embodiment of the present disclosure provides for receiving a search query including a keyword string and a geographic location; generating a survey based on the geographic location and the keyword string, outputting the survey, receiving an answer, and outputting an advertisement based on the answer. The method may further provide for receiving an indication of interest to the advertisement and outputting directions associated with the advertisement or advertiser. The method may still further provide for determining a billing amount and charging the advertiser the billing amount. According to one embodiment the billing amount may be charged to the advertiser's account.

According to another embodiment, a subsequent search result lists could be output to the customer (i.e. via email) at a later time. For instance, a customer taking a survey about vacationing in Santa Fe could instantly receive an email listing vendor advertisements related to her trip and could then receive another email two weeks before the trip dates with a refreshed list of vendor advertisements.

According to another embodiment, when no survey is required, the system can simply list the advertisers using conventional means. When the number of multiple, disparate matches, i.e., types of vendors, is returned from a given search, the survey can be dynamically modified to include questions as necessary to help include or exclude particular vendors.

Accordingly, another method according to one embodiment of the present disclosure provides for receiving a keyword string, generating a survey and a list of advertisements, outputting a survey and a list of advertisements, receiving an answer to the survey, generating an additional survey and/or a list of advertisement, and outputting an additional survey and a list of advertisements.

According to another embodiment, a method for billing an advertiser for obtaining services from a survey program is provided. According to this method, a survey program may receive from a searcher a search query including a keyword which the survey program has associated with a given advertiser. The survey program may then output a survey including one or more survey questions. The survey program may then receive the searcher's answers. The survey program may then determine if the answers correspond to the answers that are associated with an advertisement provided by the given advertiser. If the searcher's answers correspond to the advertiser's advertisement, the survey program may output the advertisement to the searcher. The survey program may then determine whether the searcher clicks on the advertisement. If the searcher has clicked on the advertisement the survey program may retrieve the billing information for the advertiser, determine how much the advertiser should be billed, and bill the advertiser the appropriate amount.

According to another embodiment, the present disclosure provides a method and system to link or embed surveys into existing websites that are linked to a central database and provide custom results based on survey answers.

Accordingly, a system is disclosed that provides an online survey which, when completed and submitted, generates a custom list of service providers or vendors or a narrowed or customized list of advertisements, website or other links, products or services that can be displayed on a website or on a computer display and may also be emailed or mailed to the end user who completed the survey. The survey can be embedded into one or more websites or other Internet or computing sites that are relevant to the information that is provided when the survey is completed. The number, type, questions, and results of the survey are customizable for each website in which the survey is embedded. In an embodiment, the system learns which questions yield better results for the vendor or suppliers or service providers, e.g., the system may determine that certain questions (and, in addition or in the alternative, which answers), provide a better means of determining which products, goods or services a given customer may be interested in and/or will ultimately buy.

For example, a survey, e.g., one or more questions, to help an end user plan a trip to Santa Fe may be embedded in the official website of the city, e.g., santafe.org; the website of the local chamber of commerce, e.g., santafechamber.org; the website of the local Santa Fe magazine, e.g., santafean.com; and/or in the intranet of the local hotel reservation engine, e.g., santafehotels.com.

The questions in the survey, the results displayed and/or emailed in response to the survey, and the way that the results are displayed are all customizable for each website where the survey is embedded for example, in one embodiment of the present invention:
1. The survey may exclude the real estate question(s) from the santafe.org website, and/or
2. The survey may display vendors in its results that are members of the Chamber of Commerce and/or
3. The survey may exclude one or more of any hotel questions on/from the santafehotel.com website and/or
4. The email guide that is sent out may be customized to look as if it has been sent from the website where the survey was completed, e.g., a survey filled out from the santafe.org has the city logo and is emailed on behalf of a city employee and/or
5. The survey on the Santa Fean magazine website might only show hotel results that have a direct link to the hotel website and does not show hotel results that are loaded from a third party reservation engine like hotels.com and/or
6. A real estate company could elect to have custom emails sent on its behalf from surveys completed on Santafean.com, but only have a link to their website listed in the email guide sent out from santafechamber.com
7. The survey form is customized to fit into various spaced on the different websites. For example the survey may be 295 by 485 pixels the santafechamber.com and 320 by 465 pixels for santafetrips.com.

As in the previous example, advertisers, search engine companies, vendors, service providers or other third parties can add survey questions that are presented to end users to help better understand the search request, query, question, or other request submitted by and end user. By answering one or more survey questions, end users provide information to those that can benefit from such additional information. Such parties can then determine if their product or service or information is suitable for presentation to the end user and in addition or in the alternative, determine the potential value of such an end user.

Survey questions may seek to:
1. Learn more about the end user, including, but not limited to learning more about his/her objectives, preferences, goals, limitations, profession, business, budget, timeline, habits, allergies, number in party or family, income level, race, ethic origin, etc. or
2. Better understand what the end user is looking for or expects to find from the search string entered into a website, or search engine, or based upon the link(s) selected, or
3. Other information about the end user and/or related individuals.

Surveys may be in the form of open ended or closed questions. Surveys may consist of only one or two questions, or may be a series of questions.

According to an embodiment, the system may employ a layered or tiered system in which end users may answer one question, which may prompt one or more additional or successive questions. Alternatively, in a non-layered system, all the questions may be presented all at one time.

Questions may be mandatory or optional, e.g., the first question may be a mandatory question, while any subsequent questions may be optional.

Questions may be in any suitable format including, but not limited to, any one or more of a) multiple choice, b) yes/no c) verbal or essay responses, c) fill in the blank, and/or d) weighted or relative ranking type questions, or a combination of any/all of these.

For example, in response to a search query about hotels, the system might ask questions such as: “Do you prefer a regular room or a suite?” or “What is your hotel room budget?” In response to a search query about horses, a question might be: “Are you interested in A) Riding Horses, B) Buying Horses, C) Taking a Vacation on a Horse Farm, D) Learning more about Horses, E) Reading a Fictional Story about Horses, or F) None of the above.”

In response to a search question about vacations, the system might ask a first question such as: “Do you want an all inclusive vacation?” If the end user answers yes to that question, the system might then ask: “Would you prefer a cruise or a land based vacation?” Based upon the end user's response to this question, the system might ask yet another question to further categorize this particular end user's wishes.

According to an embodiment, the central system that manages the surveys can split the revenue (equally or disproportionately) generated from vendors who display advertisements in response to appropriate answers to the survey with the owners of the websites where the surveys are embedded. For example, the central system (or other processing site) may receive $1 to list a vendor in a survey. When the survey is completed on the santafe.org website (for example), the central system provider may be obligated to pay 20% of $1 to the City of Santa Fe, based on their contractual relationship or other prior agreement. This revenue split can be customized for each website where the survey is embedded.

Fees for surveys may be based upon any suitable factor including, but not limited to one or more of the following: a) the number of questions in the survey, b) the number of competing vendors, c) the probability that an end user will select a particular vendor, d) the actual selection of a particular vendor, e) the expected value of the transaction, f) the actual value of the transaction, i.e., generated revenues, g) the present value of all transactions (current and future) as in the case of a magazine subscription, h) the answers to the questions, l) the combination of answers to questions, j) clicking on a specific link, k) vendor response, e.g., size of advertising material to be mailed, l) any other factor(s) agreed upon by the affected parties, and/or market forces, e.g., a bidding system, auction, or reverse auction, etc.

Revenues from vendors may be split up by the central system and the websites where the surveys are embedded for different types of advertisements including any one or more of the following, but not limited to:
1. A listing on the survey results or other page
2. A listing in the email guide (or its physical mail equivalent)
3. An inclusion of a brochure or other advertisement that is mailed to the end user who took the survey
4. An automated email or physical mail sent out from the central system on behalf of the advertiser
5. A click on a link that directs the end user to the website of the advertiser from the survey results page of a website, the email guide, or the automated email
6. A response to the automated email or mail
7. A reservation email sent from clicking on a link of the listing on the survey results page or email guide
8. A click on a link along with a transfer of data collected from the survey to the website or reservation engine of the vendor.
9. A payment for a good or service or information

According to one embodiment, vendors can log in and select which survey results on which websites they want to be listed. For instance, a real estate company may want its website advertised in survey results where the end user indicated she was interested in real estate only on santafe.org and santafechamber.org but not on santafean.com

According to an embodiment, an end user may respond to a survey by clicking check boxes, radio buttons or other selection types, selecting yes or no answers, picking answers from a list of answers, filling out answers, ranking answers from high to low in terms of relevancy or weighting answers (e.g., by moving “slider bars” to indicate which answer(s) are more or less relevant, verbally via a microphone attached to the input device, such as a PC, or by any other suitable means.

In another embodiment, the system tracks actual rates of conversion (i.e., the percentage of those responding to certain questions in certain ways and/or that actually purchase a good, product, or service) and learns from such responses. As the system learns, the questions may be modified and the more successful questions are presented to prospective customers based upon what has been learned and/or based upon any one or more characteristics of the survey respondent (that is known or that can be determined) and/or the website hosting the survey, including, but not limited to the respondent's a) age, b) income, c) net worth, d) buying history, e) personal interests, f) sex, g) race, h) home or business address, i) occupation, j) time to purchase, k) credit history or score, l) hobbies, or any other personal demographics such as number of people in the household, or number of children and/or attributes of the website such as whether or not the site offers a service, product, good, or is a marking site that passes qualified prospects to yet another website(s).

Learning can be accomplished by tracking statistical information, or by using any of several learning or adaptive agents/systems/methods that are well known within the art such as Bayesian algorithms.

In an embodiment, selection of an item from a list of items (e.g., links) may equate to “answering a question.”

In another embodiment, as a respondent is entering a response or search string, the system may determine other words that are similar to or are synonyms of one or more words in the response and/or search string and display such synonyms to the respondent for their consideration or use. For example, as a respondent enters the string “horse ranch” the words “dude ranch” and “formal riding” and “western ranch” might be displayed.

In yet another embodiment, such synonyms may be determined and/or their sort order may be based upon what the system learns over time about which strings are more likely to be used in stead of the response and/or search string. Such learning may be accomplished using generally known statistical or adaptive learning methods all of which are well known in the art.

In another embodiment, the sort order of the responses to the end user's search query may be affected in whole or in part based upon a fee paid by a third party or provider to receive a preferential position. Such preference may be based upon an absolute position and/or based upon learning which position(s) yield the best conversion rate (which sort order may or may not be sequential).

In another embodiment, the system may send customized marketing materials to the end user from two or more providers. The materials may be sorted by using any suitable means including, but not limited to: a) randomly, b) in order of probability of conversion, c) the order of relevance (based upon respondent's answers and/or other attributes, d) by fee amounts paid for preferential sorting, e) by expected fee amounts due if the respondent becomes a customer, and/or any combination of these criteria.

In an embodiment, selection of an item from a list of items (e.g., links and/or synonyms) may equate to “answering a question.”

According to another embodiment, the survey can be embedded into the search engine browser. For instance, the survey could be placed in the search toolbar of search engines such as those provided by companies such as Google, Microsoft and/or Yahoo.

According to another embodiment, different clones could provide links to different reservation engines. For example, a travel survey for Santa Fe could be embedded in the local chamber of commerce website, santafechamber.com and the local city website, santafe.org. The clone could show reservation data for hotels from the hotels.com inventory on the santafechamber.org website and reservation data for hotels from Travelocity on the santafe.org website.

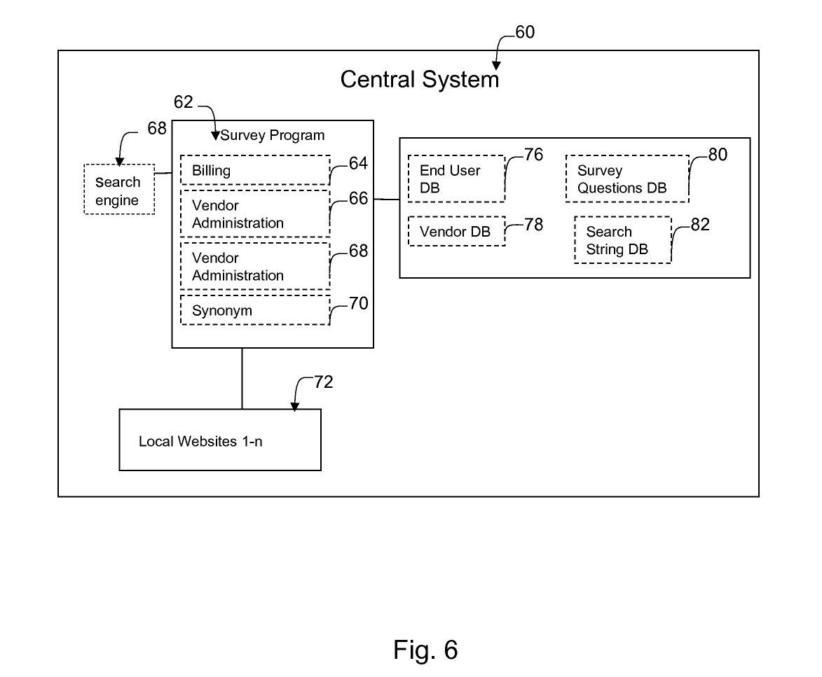

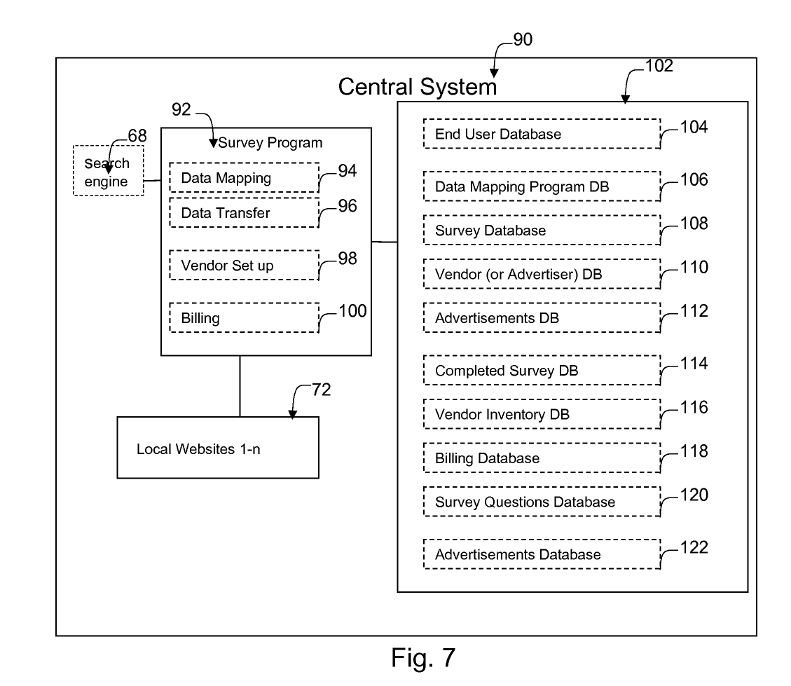

FIG. 6 provides as exemplary system 60 according to one embodiment of the present disclosure.

As shown in FIG. 6, system 60 may include a Survey Program 62. Survey program 62 may contain static or dynamic survey questions. According to an embodiment, the program determines which end users will receive questions and which questions will be presented. Selection of questions may be based upon any one or more of the following, for example: a) the search engine, b) the end user, c) the end user's profile, d) the end user's search string or query, e) the vendors listed by the search engine, f) a probability of a purchase by an end user as determined by the outcome of previous searches and/or responses to similar or the same survey questions and/or end user demographics and/or any combination of these factors. Questions may be predetermined, i.e., fixed questions based upon specific search strings, and/or randomly selected, and/or determined by a learning algorithm, such as a Bayesian logic or a neural net, or other learning methods that are well known in the art, and/or established by the vendor(s) and/or service providers, and/or search engine provider, and/or any combination of these, and/or by using an expert system or other rules based system(s) which are well known in the art. Questions may be changed over time by any of the forgoing, and/or new questions may be added to the database for subsequent presentation and testing for success and/or click through rates. In addition to the forgoing, the survey program may further be configured to a) evaluate each end user, using any information available at the time a query or search string is submitted (e.g., end user demographics, search engine type, search string contents, search engine query response list and vendors, etc.), and then determine which survey question(s) are most appropriate to present to the end user, b) present the appropriate question(s) directly to the end user or pass the information to the search engine or requesting website for subsequent presentation to the end-user, c) receive and process responses from the end-user (whether directly or by receiving the response from the end user or the end user's search engine's website or the requesting website or otherwise, e.g., a travel site with an embedded survey program), d) determine which new or additional list(s) of vendors, advertisements, or links or otherwise are most appropriate given the answer(s) to the one or more presented survey question(s), e) present the new or modified list as determined in the previous steps, to the end user or pass the results to the requesting program, e.g., the search engine or travel website, f) await the results of any subsequent actions taken by the end user, such as the end user clicking on any one or more of said links or modified or new vendors, or links, and pass any appropriate and/or available information to all interested and/or affected parties, including, but not limited to, for example, the search engine, travel site, other website or link, etc., e.g., any third party that may benefit from or be affected by the actions (or inaction) by the end user and/or those that may be charged for the presentation of the questions and/or charged based upon the subsequent decisions, purchases, clicks, actions or otherwise by the end-user or those affected or that could be affected or benefit by or from such knowledge about the end user, and/or the end user's search string, responses to one or more questions, actions or failures to act or respond to any subsequent modified or new list of vendors and/or links, or otherwise, g) pass any part or all of said results to any participating or otherwise affected parties as appropriate or as agreed upon by and between the requesting website, e.g., search engine or travel site or city website, or vendor website, etc., so that any interested and/or affected parties can take any subsequent or further action, e.g., display a webpage, or an advertisement, or link, or send a package of information via e-mail or mail, or via other form of communications and/or store such information for subsequent processing, e.g., add the end user to a mailing list, h) pass along billing information, which billing information may be determined before, during and/or after the end user's initial request, response to one or more questions, actions before or after responding to any such questions, i) receive a response from a party that may be billed, e.g., to determine if one or more vendors wish to respond to the end user or present one or more questions based upon the search string, and/or survey questions, and/or the end user's responses to one or more questions, and/or the cost based upon any of the following in the event the end user clicks on the vendor's link or advertising or otherwise purchases a good or service from one or more vendors, and j) store data in a database of the transaction, results, click through information, etc., for subsequent learning and other uses and k) pass required data to the billing program to send billing information to all appropriate parties and manage and track collections related to each transaction and/or the customer service program, which may include features to follow-up with the end user to ask additional questions and/or request the end user to fill out a customer satisfaction survey.

System 60 may also include a Billing Program 64. While shown in FIG. 6 as being as a subprogram of survey program 62, it will be understood that like any of the other programs described herein, billing program 64 may be a self-contained program, or a part of one or more other programs running on the same or a different server as the server on which the survey program 62 is running. According to an embodiment, billing program 64 may be configured to receive information from the survey program and to send bills to any affected parties and to monitor their payments, including monitoring of aging accounts, etc.

System 60 may also include a Vendor Administration Program 66. According to one embodiment, vendor administration program 66 may be configured to store and process information about vendors, including but not limited to vendors, service providers, search engine companies, travel companies, localities, etc. The information stored and processed by vendor administration program 66 may include, but is not limited to, information regarding a vendor's desire to participate in the survey programs, payment terms, preferences regarding types of end users, survey questions, sequences or priority of questions, answers, limits on costs or billing, payment preferences and payment information, e.g., credit card or other terms, presentation preferences, e.g., order in list of vendor links, advertisements, willingness to bid on one or more end users, or end user types, or end user responses to specific or generic survey questions, etc., willingness to participate in an auction or other sale of prospective customers, and the like.

System 60 may further include a Search Engine 68. Search engine 68 may be configured to parse a search string submitted by an end-user using any of many well know methods such as those used by Google, to determine an initial list of vendors, search results, sponsors etc., and then to actively or passively supply the information to the survey program, which may be resident on and an integral part of the search engine application or which may be a separate program running on the same or different equipment (e.g. server) or website or any combination of these.

In an embodiment of the present invention, a search engine user interface (not shown) is used to present and process the user interface components of the survey questions. In another embodiment, the survey questions appear via a separate webpage or “window” that operates independently of the search engine's user interface and/or application. In another embodiment, the results of the survey questions are returned to the search engine for subsequent processing, e.g., to modify the original list of vendors, results and/or sponsors, given the end user's responses to the survey questions. In yet another embodiment, the revised list of vendors, results and sponsors appear on a separate “window” or webpage, which webpage may or may not be generated or displayed or managed by the calling search engine.

Methods to analyze an end users search string and methods to improve such analysis is already well known within the prior art and anyone skilled in the art would readily appreciate that there are many methods that could be employed to perform the initial and/or subsequent parsing of the search string and/or the survey questions in order to determine the best vendor or list of vendors and/or search results based upon either the search string and/or the survey questions individually or collectively. Furthermore, anyone skilled in the art of learning systems would readily appreciate that various methods could be employed to enable the system to learn from the search string(s) entered and/or any available end user demographics and/or any responses to any survey questions, each individually and/or in any combination so as to permit the system to improve the results or outcome for any given transaction, e.g., search and/or survey over time. Improved results may mean any one or more of a) revenues generated (short or long term), b) end user satisfaction with the search engine and/or the survey questions and/or the survey process, c) vendor satisfaction based upon end user reported satisfaction, and/or revenues received and/or revenues received vs. the cost for such revenues, i.e., fees charged for the search and/or survey, d) click through rates, e) search engine company satisfaction based upon revenues generated by the search and/or survey results and/or received by vendors, and/or vendor reported satisfaction, and/or end user reported or surveyed satisfaction, f) any other business logic, rules or success criteria determined by the search engine company and/or the vendors and/or the owner/operator of the survey application or any combination of these.

System 60 may further include a Synonym Program 70. Synonym program 70 may be configured to determine and/or retrieve possible or known synonyms to a word or search string. This program may be manually administered, e.g., humans can create a list of synonyms and/or it may be automated. An automated program may start with a known list of synonyms such as the list contained in Merriam-Webster's dictionary of synonyms, or it may start with no known list of synonyms, or a subset of synonyms. The program can learn which words are synonyms in any one or more of the following ways including a) associating words entered by end users, with words actually or finally selected by end users, b) by observation of click through activity, c) manual entry by end users, vendors, service providers, search engine operators, or any authorized third parties, or d) through use of any of several well known learning algorithms. As the system increases its list of synonyms, the relevancy of one word to another word or a group of words to a word or a group of words can be determined over time via manual or automated methods. As these associations become known or their relevancy is determined or refined, synonym program can store the synonyms and their relevancy to each other for subsequent use. In and embodiment of the present invention, such synonyms are used to a) be displayed to end users and/or passed to search engines or other websites or applications to be used to improve search results (such display or use may or may not be associated with the Survey Program, e.g., as end users enter search words or strings, the Synonym Program may begin immediately displaying synonyms on the search results or other results page for reference and/or use by the end user, and/or the search engine may use such synonyms to display to the end user and/or use the information to improve its search engine algorithm's results and/or to help improve sorting the results so that they may be more relevant given the search word or string. In another embodiment, the survey program uses synonyms to help determine relevant survey questions and/or to improve its result sets, e.g., choosing relevant vendors or other third parties based upon the synonyms and/or answers to survey questions or any combination of these.

System 60 may further include one or more Local Websites 72 which may host and/or display a survey program or provide a communications link to a remotely located survey program.

System 60 may further include a plurality of Databases 74 including, for example, but without limitation to, the following:
1. End user information database 76, which may collect and store information such as:
   a. End user ID or IP address
   b. End user Password
   c. End user name and address
   d. Demographics
   e. Prior history database
   f. Preferences
   g. Questions and/or response
   h. Billing information
2. Vendor information database 78, which may collect and store information such as:
   a. VendorID
   b. Vendor Password
   c. Vendor Name
   d. Vendor Website Address (1-n)
   e. Payment Terms
   f. Payment Type
   g. Credit or other Payment instrument (e.g., wire transfer or billing information)
   h. Fee Options, e.g., willingness to participate in auction, fixed or percentage fees, premium sponsor, etc.
   i. Vendor address
   j. Vendor question IDs 1-n
   k. Vendor preferred or ideal responses to each question above 1-n
   l. Questions weighting factors (e.g., which are more or less important) 1-n
   m. Additional fee option (e.g., willingness to pay more given certain survey question responses.
3. Questions Learning Database database 79, which may collect and store information such as:
   a. Relevancy Score
   b. Answers Ranking Score
   c. Order Preference Ranking/Relevancy
4. Survey Questions Database database 80, which may collect and store information such as:
   a. Question ID
   b. Question Name
   c. Question Type
   d. Question Category
   e. Sequence Number
   f. Subsequent Question ID (1-N)
5. Search String Database database 82, which may collect and store information such as:
   a. Search String (may be specific string or group or category of strings)
   b. Related Search Strings (i.e., synonyms) 1-N
   c. Survey Question Ids (1-N)

According to an embodiment, system 60 may be configured to facilitate an Initial System Setup by the vendor as follows:
1. Vendors enter information via the Vendor Administration Program
2. Vendors add Vendor information and questions into Survey Questions Database
3. Vendors link survey questions to search strings and rank each question in terms of relevancy
4. Vendors rank possible responses in terms of relevancy and value
5. Survey Display Program calculates fees and requests vendor approvals
6. Vendors approve fees

According to an embodiment, system 60 may be configured to facilitate an Initial System Set up by a Search Engine Company as follows:
1. Search engine company employees or designees or vendors enter information via the Vendor Administration Program
2. Search engine company employees or designees add Vendor information and questions into Survey Questions Database
3. Search engine company employees or designees link survey questions to search strings and rank each question in terms of relevancy
4. Search engine company employees or designees rank possible responses in terms of relevancy and value
5. Survey Display Program calculates fees and requests vendor approvals
6. Vendors approve fees

According to an embodiment, system 60 may be configured to facilitate Survey Operations by performing steps as follows:
1. End user enters search string on search engine or other website
2. End user may enter additional information
3. Search string and preliminary results are passed to the survey program
4. Initial results may or may not be immediately displayed while the survey program conducts its analysis
5. As or if available, retrieve, End User information, Vendor Information, Rules, Survey Questions and rules or business logic from the databases
6. Survey program, using as much information as is made available, determines appropriate survey questions, number, type and sequence
7. Survey program presents one or more questions in the appropriate order to the end user (or the calling program, e.g., search engine as appropriate)
8. End user enters one or more responses to survey questions or ignores them or quits
9. End user may enter additional information, e.g., name, address, income level
10. If end user answers the questions, answers are analyzed by the survey program to determine which specific vendor or category of vendors or list of vendors that best match initial search string and survey responses given business objectives and/or rules, and/or learning algorithms results and/or expected revenues and/or a combination of the above and/or determines applicable synonyms by executing the synonym program.
11. Survey program passes results to search engine (if required/applicable)
12. Survey program (or search engine) presents modified results to end user
13. End user either selects from among the modified list or enters a new search string, or selects a synonym or quits
   a. If the end user selects from the modified list, display the appropriate webpage(s), update the database
   b. If user enters a new search string and/or selects a synonym, restart the survey program using the new search string or synonym
   c. Else, wait for further end user response and/or execute vendor “proactive” ads and/or update databases and return to start.
14. Execute Billing Program and pass results of end user activity and search results
15. Execute Learning Algorithm
16. Update databases
17. Wait for further end user, search engine or vendor instructions / actions
18. Return to start

According to an embodiment, billing program 64 may be configured to perform some or all of the following steps:
1. Receive results from Survey Program
2. Retrieve billing rules and payment terms from database
3. Determine charges
4. Notify affected vendor(s) or others of fees/charges
5. Update databases
6. Await payment
7. If payment is not made timely, notify vendor(s) or other delinquent parties and place a hold on subsequent surveys for said vendors/parties and/or charge a higher fee to credit card on file

According to an embodiment, Synonym Program 70 may be configured to perform some or all of the following steps:
1. Receive search word or string (or portions thereof) from end user or search engine or website, etc.
2. Look up individual words and/or strings within synonym database.
3. Retrieve synonyms and rank according to relevancy to search word or string
4. Retrieve display results rules
5. Send results and display/use rules to search engine and/or website and/or survey program as required and applicable
6. Display synonyms as applicable and according to display rules (if any and as required)
7. Receive indication that end user or third party clicks on synonym
8. Update relevancy database
9. Execute learning algorithm

According to an embodiment, system 60 may be configured to provide a survey and facilitate an end user filling out a survey that may include (in the example of a travel survey) informational requests such as:
1. End user name
2. End user email address
3. End user mailing address
4. End user phone number
5. Dates of a potential visit
6. Selections of Categories of:
   a. Lodging
   b. Events
   c. Activities
   d. Shopping
   e. Real Estate

According to another embodiment, the present disclosure provides a method and system to transfer data that is collected in an online survey to the website of a vendor who has paid to have a link to his website be displayed when certain survey criteria is met.

According to the embodiment, an end user fills out an online survey that is embedded in (or dynamically included in and/or linked to) a website, webpage or search engine tool. Based on the survey responses, links to appropriate vendor websites are displayed and/or the end user is redirected to the most appropriate webpage, website or other site. When the end user clicks on a link (if required), and/or if the end user is automatically redirected to the webpage, vendor website, or secondary search engine, (each or all collectively referred to herein as a “website”) the data that were collected in the survey are passed to the website so that the website can analyze and use the information and display results, pages, offers, and/or information that are tailored to the survey responses and/or other respondent demographics.

For example, an end user visits or displays a website and completes a survey about making a trip to Santa Fe. The survey may include any one or more of the following, but not limited to: the end user's name, email address, phone number, dates they are planning to make a trip, people in party, budget amount or range and the type of lodging they are or may be interested in (and/or other end user demographic, billing or personal information). It would be readily apparent to anyone skilled in the art to appreciate that the number and type of questions may vary from website to website and may be determined based upon any of numerous factors including information known about the website, its goals, objectives, marketing partners, inventory, current or projected demand for the website's products, goods, or services, room availability and type, pricing (both current and projected, and/or special offers, packages, online deals, suggestive selling offers), current or anticipated marketing programs or offers, competitive information of any of the forgoing, including competitor's current pricing and product or services availability, etc., and/or any information previously known or otherwise acquired, and/or information collected from the website and/or the survey. For example, if the end user's income level is already known, asking such a question may not be efficient or productive. In addition to affecting or determining the number and types of questions, knowing information about the website or end user may also affect or determine possible question responses, for example, if you know the end user's income level (whether previously known and/or gathered via a survey question or gathered through other means, e.g., using the end user's name and other information to purchase or otherwise access financial records or other data regarding the end user, e.g., pulling a credit report, you might add or eliminate certain response choices, e.g., a multiple choice question might have one or more answers added or eliminated based upon the end user's income or other financial information. For example, if the end user is particularly wealthy, the choice for the President's suite for a hotel provider might be the first choice in a list of room preferences in the survey, conversely, an end user with modest income might not even see an option for the President's Suite or it may be last on the list of possible choices. By using known information, and/or gathering unknown information, websites can best determine what information, links, offers or web pages to subsequently display. Questions may be asked sequentially or in groups or all at once. In an embodiment of the present invention, a first question is asked based upon any one or more of the website(s) visited, the known information about the end user, randomly, targeted or key questions or initial classifying question(s), etc., upon receiving a response from the end user, subsequent questions and answer options may be determined and presented. The sequence may be designed to complete the survey with as few questions as possible, and/or to obtain as much information as the end user is willing to provide. In another embodiment, the number of questions may be determined in whole or in part by the end user, via a response to a question such as: how many questions are you willing to answer to give you the best possible response? 1, 5, 10, or more? In this example, the end user might choose 5 questions. Based upon this information, the system may change the order and/or type of questions so as to maximize the resulting information, while keeping the number of questions to the end user imposed limit. Questions may be in any suitable format including, but not limited to, yes, no, or maybe type answers, multiple choice answers, check box or radio button options, fill in the blanks or essay type questions or any combination of these options.

According to an embodiment, when the end user responds to or otherwise submits the survey, links to appropriate vendors and/or other websites may be displayed and/or additional qualifying or classifying questions may be presented. For example, upon answering a first question or first set of questions, a first set of links may be displayed, or a second question or list of questions may be displayed or both. For example, if an end user enters the search string “Santa Fe Travel” a question such as: “Are you interested in flights, hotels, cars, packages, or all of the above?” If the end user responds by clicking on hotels, a list of links to local lodging providers may be generated and displayed on a subsequent page of the website and/or as a popup or separate window or unique webpage. In addition or in the alternate, a secondary question may be displayed, e.g., “How many stars 1, 2, 3, 4, 5 or resort?” Links may also be generated and emailed or sent via instant messaging or other communications method to the end user. When the end user clicks on one or more of the links, and/or answers one or more survey questions, the data, collected, including, for example, the name, dates and number of people in party she provided in the survey (along with any other information available) is transferred to the lodger's website and/or to other participating website(s) where it is mapped to data reception fields in that website's database and/or it is transferred to an application within said website's system, so that the lodger's website can analyze and use the information to determine what webpage, information, or additional questions to display. For example, in the case of an end user interested in lodging, the receiving lodger's website might display availability of various rooms or room types for the dates and times specified by the end user in response to a survey question regarding travel dates or preferences. In addition or in the alternate, the lodger's website might display alternative dates when prices are lower or there special offers available on such dates. The type of display to deliver to a particular end-user may be determined by whether the end user indicated she was flexible as to the travel dates. Of course, alternative dates may be displayed regardless of the user-input received and/or user-specified/user-identified preferences. The end user's name (and/or any other available data that has been collected or otherwise acquired) can also be automatically filled into i.e., mapped to, the data reception fields for the name within the lodger's system or database or application, thereby eliminating the need for the end user to reenter that data at the vendor's website.

Various methods to permit transfer of information between two websites are well known in the prior art any may be employed. Non-limiting well-known methods include the use of XML interface methods.

It would be readily apparent that there are numerous methods to map data, transmit data, store data, or otherwise make use of the information gathered via the survey process. Accordingly, any such suitable methods may be employed.

According to another embodiment, the Vendor's programming personnel and/or unskilled or skilled maintenance workers, or a third party or support organization, or other personnel (individually or collectively the “maintenance person”) can log in to an administrative tool to indicate how the data that is collected from a survey is mapped to the data fields of their website's database, application or system. Such mapping may be accomplished via a graphical user interface, or via text instructions, such as programming instructions. In the case of a graphical user interface, for example, the maintenance person could, using a mouse for example, point to a source data object, e.g., the person's first name, and then point to a database field in their database. The mapping program could determine if the two fields are compatible and, optionally display any variances. The system could automatically map the data, e.g., name, and modify the data as necessary to ensure compatibility. For example, in the event that the source first name field is longer than the destination name field, the system could perform any one or more of the following steps: a) truncate part of the name (either at the beginning or end of the name) to force a fit into the destination name field, b) search a database of first names to see if there are acceptable alternatives, e.g., substitute the name Bill for the entered name William, or c) display these options to the maintenance person to permit them to select from among a list of predetermined mapping options and/or permit the maintenance person to enter his own mapping method, algorithm, process, etc. It will be appreciated that there are a wide variety of data types and mapping issues, each with one or more alternative mapping solutions. The list of data types, and field lengths and characteristics, which includes, but is not limited to a) numerical fields, with varying levels of precision, b) alpha fields, c) alphanumeric fields, d) and many others, such as those of the Java language including byte, short, int, long, float, double, Boolean, etc. Methods to map data from one data type to another are well known in the prior art. In an embodiment of the present invention, maintenance persons are permitted to determine such mapping themselves, either partially or completely automated while in another embodiment, maintenance persons are precluded or prevented from modifying existing mapping instructions and/or default mapping methods. For example, maintenance personnel may be permitted to truncate certain source data, e.g., a first name, so as to fit the source data to the destination database field size, while they may be prohibited from truncating numeric data.

In an embodiment, website owners, survey program owners or providers, third party technical personnel and/or maintenance persons may be permitted to perform any one or more of the following mapping tasks: a) direct mapping from one field to another field that is of the same or other compatible data type and/or length, b) combine or divide one or more fields and map the resulting data to one or more fields, c) apply a filter or mask onto one or more fields to filter or otherwise modify data and map the resulting data to one or more fields, d) create a data reformatting algorithm to transform data from one or more fields into resulting data that may be mapped to one or more fields, such algorithms may be standardized and selected from a list of program options or created as a custom program and added to any such standard list of algorithms, e) create an application that processes one or more source data fields and maps same to one or more results data fields, f) select from one or more database tables, or incoming data packets, e.g., an XML record, for the source data, and select from one or more database tables and/or destination or intermediate database tables or data packets, g) join one or more tables, or h) any other database or communications programming methods or database transformation methods that are well known and understood within the prior art and by anyone with ordinary skill in the art, including programmers skilled in designing systems that receive, transform, map, or otherwise manipulate data, databases, communications packets, or database information.

According to an embodiment, vendors may be required to pay an additional fee to receive part or all of the data. Such fees may be one time charges, or in addition or in the alternate, per use charges. Fees may be based on the total amount of the data, relative quality or quantity or both of the data, relative usefulness of the data, or the accuracy of the data, or any other factors that may be agreed to by the vendor (i.e., the recipient of the data) and the provider of the data. Certain of the data may be provided without additional charge. All or part of the data may be provided for a flat rate fee. Each field may require a separate fee. Fees may be fixed, dynamic, or may be based upon the probability of converting a given respondent, and/or a percentage of the revenues generated through conversion of a given respondent, etc.

In an embodiment, selection of an item from a list of items (e.g., links) may equate to “answering a question.”

According to an embodiment, the system could “ping” a central reservation engine, such as those provided by hotels.com to check to see if there is inventory for a particular hotel. If there is inventory, the listing is displayed with a link to the hotels.com pricing engine. If there is not inventory, the listing displays a link to go to the hotel website and passes the reservation data to the hotel website. Links to hotels.com and directly to the hotel's website can be simultaneously displayed.

According to an embodiment, different pricing or advertisements for various activities could be made available based on information gathered from the survey. For instance a survey coming from a resident of New Mexico could receive a preferred rate on hotel rooms displayed in the survey.

In another embodiment, the price a search engine or other website charges a vendor or group of vendors to list their links (or to redirect an end user to one or more websites or web pages), as the results output of a given search, may be determined or otherwise affected, in whole or in part, by the answers to the survey questions. For example, a customer interested in an “around-the-world” cruise, may be worth more potential revenue than a customer interested in a “weekend getaway.” Accordingly, search engines could use answers to survey questions to: a) determine the more appropriate list of links, e.g., vendors, given a certain set of questions and responses, b) display the list or sort the list based upon such answers, c) select or charge the vendors based upon the potential revenue to the search engine or the vendor, d) charge one or more of the vendors based upon the data gathered, e) submit the responses to a list of vendors and seek bids from each to i) be listed or ii) determine a position in the list, e) determine what marketing offer(s) to include with each or selected vendor links, f) determine what marketing tag line, slogan or “sound bite” to include with one or more links, or g) any one or more or any combination of the foregoing.

In another embodiment, mapping may be managed by the website and “pushed” to the receiving vendor site(s) or the receiving websites may request specific data and/or formats for data from the sending website, i.e., “pulled”

In another embodiment, charges for data may be additionally based upon the number of times the data are used or the length of time the data may be stored, e.g., one hour, week, month, year or indefinitely.

In another embodiment, end users may request that confidential information not be shared, but, instead, “cleansed” of such personal or confidential information prior to transmission to any third party. End users might indicate such a preference before or during a transaction, e.g., selecting a check box to indicate their preference or indicate their preference when signing up with the website. In this case, certain of part or all of the data may be deleted, modified, or otherwise stripped of specifically identifying data, e.g., the end user's name, while other data may be supplied in tact, such as the end user's travel preferences or income level, which level may be changed from a specific annual income to a range of income levels.

FIG. 7 provides a system 90 according to one embodiment of the present invention.

As shown, system 90 may include a Survey Program 92, a data mapping program 94, a data transfer program 96, a vendor set up program 98 and a billing program 100.

System 90 may further include a plurality of databases 102.

System 90 may include an End User Database 104, configured to track and store information such as:
1. End user ID or IP address
2. End user Password
3. End user name and address
4. Demographics
5. Prior history database
6. Preferences
7. Questions and/or response
8. Billing information

System 90 may include a Data Mapping Program Database 106 configured to track and store information such as:
1. Sending Database File ID
2. Sending Database File Definitions/Metadata (1-N)
3. Data Types, lengths, filters, masks, etc. (1-N)

System 90 may include a Survey Database 108 configured to track and store information such as:
1. Question ID
2. Question Name
3. Question Type
4. Question Category
5. Sequence Number
6. Subsequent Question ID (1-N)
7. Keywords (1-N)
8. Keyword Relevancy Scores (1-N)

System 90 may include a Vendor (or Advertiser) Database 110 configured to track and store information such as:
1. Advertiser ID
2. Advertiser Password
3. Advertiser Name
4. Advertiser Website Address (1-n)
5. Payment Terms
6. Payment Type
7. Credit or other Payment instrument (e.g., wire transfer or billing information)
8. Fee Options, e.g., cost for one, two or more advertisements, static and/or dynamic, and/or tests for variable positions and/or variable ads, and/or use of synonyms and/or use of surveys.
9. Advertiser address
10. Advertiser question IDs 1-n
11. Advertiser preferred or ideal responses to each question above 1-n
12. Questions weighting factors (e.g., which are more or less important) 1-n
13. Additional fee option (e.g., willingness to pay more given certain survey question responses.
14. Advertisement weighting factors (e.g., which are more or less important and/or more or less effective) 1-n
15. Additional fee option (e.g., willingness to pay more given certain survey question responses and/or advertisement selection, e.g., selecting an ad for a hotel with a description of “first class accommodations” may require an advertising fee greater than an add for the same advertiser and same hotel but using an add reading: “great weekend deals”.

System 90 may include an Advertisements Database 112 configured to track and store information such as:
1. Advertiser ID
2. Product, Service, or Good ID (1-N)
3. Description (1-N)
4. Keywords/Search Strings (1-N)
5. Advertisements (1-N)
6. Advertisement Effectiveness Score by Position (1-N)
7. Advertisement Effectiveness Score by Keyword or Search String (1-N)
8. Click Through Rates for All of the above (1-N)
9. Actual and average Revenues Generated for each of the above (1-N)

System 90 may include a Completed Survey Database 114 configured to track and store information such as:
1. Question ID
2. Question
3. Possible Answers
4. Answers

System 90 may include a Vendor (i.e., Advertiser) Inventory Database 116 configured to track and store information such as:
1. Advertiser ID
2. Inventory ID (1-n)
3. Inventory Name
4. Alternative ID (1-n)
5. Primary Unit of Measure
6. Alternative Units of Measure or conversion factors (1-N)
7. Quantity on hand (by date if applicable)
8. Quantity on order (by date if applicable)
9. Price
10. Custom or special pricing (1-N)
11. Custom or special pricing terms, conditions or limitations (1- N)

System 90 may include a Billing Database 118 configured to track and store information such as:
1. Invoice ID
2. Vendor or Advertiser ID
3. Transaction ID
4. Transaction Date
5. Transaction Type
6. Billing Terms/Conditions ID
7. Payment Terms/Conditions ID
8. Invoice Amount
9. Invoice Due Date
10. Late Fees or other Charges

System 90 may include a Survey Questions Database 120 configured to track and store information such as:
1. Question ID
2. Question Name
3. Question Type
4. Question Category
5. Sequence Number
6. Subsequent Question ID (1-N)
7. Keywords (1-N)
8. Keyword Relevancy Scores (1-N)

System 90 may include an Advertisements Database 122 configured to track and store information such as:
1. Advertiser ID
2. Product, Service, or Good ID (1-N)
3. Description (1-N)
4. Keywords/Search Strings (1-N)
5. Advertisements (1-N)
6. Advertisement Effectiveness Score by Position (1-N)
7. Advertisement Effectiveness Score by Keyword or Search String (1-N)
8. Click Through Rates for All of the above (1-N)
9. Actual and average Revenues Generated for each of the above (1-N)

According to an embodiment, Vendor Set Up Program 98 may be configured to store and process information about vendors (i.e., advertisers), including but not limited to advertisers, advertisers, service providers, search engine companies, travel companies, localities, etc., regarding their desire to participate in the survey programs, their payment terms, their preferences regarding types of end users, survey questions, sequences or priority of questions, answers, limits on costs or billing, payment preferences and payment information, e.g., credit card or other terms, presentation preferences, e.g., order in list of advertiser links, advertisements, willingness to bid on one or more end users, or end user types, or end user responses to specific or generic survey questions, etc., and their willingness to participate in an auction or other sale of prospective customers.

Survey Program 92 may contain static or dynamic survey questions stored in Questions Database 120. The program may determine which end users will receive questions and which questions will be presented. Selection of questions may be based upon any suitable factors including, for example, any one or more of the following: a) the search engine, b) the end user, c) the end user's profile, d) the end user's search string or query, e) the advertisers listed by the search engine, f) a probability of a purchase by an end user as determined by the outcome of previous searches and/or responses to similar or the same survey questions and/or end user demographics and/or any combination of these factors. Questions may be predetermined, i.e., fixed questions based upon specific search strings, and/or randomly selected, and/or determined by a learning algorithm, such as a Bayesian logic or a neural net, or other learning methods that are well known in the art, and/or established by the advertiser(s) and/or service providers, and/or search engine provider, and/or any combination of these, and/or by using an expert system or other rules based system(s) which are well known in the art. Questions may be changed overtime by any of the forgoing, and/or new questions may be added to the database for subsequent presentation and testing for success and/or click through rates. In addition to the forgoing, the survey program may be configured to a) evaluate each end user, using any information available at the time a query or search string is submitted (e.g., end user demographics, search engine type, search string contents, search engine query response list and advertisers, etc.), and then determine which survey question(s) are most appropriate to present to the end user, b) present the appropriate question(s) directly to the end user or pass the information to the search engine or requesting website for subsequent presentation to the end-user, c) receive and process responses from the end-user (whether directly or by receiving the response from the end user or the end user's search engine's website or the requesting website or otherwise, e.g., a travel site with an embedded survey program), d) determine which new or additional list(s) of advertisers, advertisements, or links or otherwise are most appropriate given the answer(s) to the one or more presented survey question(s), e) present the new or modified list as determined in the previous steps, to the end user or pass the results to the requesting program, e.g., the search engine or travel website, f) await the results of any subsequent actions taken by the end user, such as the end user clicking on any one or more of said links or modified or new advertisers, or links, and pass any appropriate and/or available information to all interested and/or affected parties, including, but not limited to, for example, the search engine, travel site, other website or link, etc., e.g., any third party that may benefit from or be affected by the actions (or inaction) by the end user and/or those that may be charged for the presentation of the questions and/or charged based upon the subsequent decisions, purchases, clicks, actions or otherwise by the end-user or those affected or that could be affected or benefit by or from such knowledge about the end user, and/or the end user's search string, responses to one or more questions, actions or failures to act or respond to any subsequent modified or new list of advertisers and/or links, or otherwise, g) pass any part or all of said results to any participating or otherwise affected parties as appropriate or as agreed upon by and between the requesting website, e.g., search engine or travel site or city website, or advertiser website, etc., so that any interested and/or affected parties can take any subsequent or further action, e.g., display a webpage, or an advertisement, or link, or send a package of information via e-mail or mail, or via another form of communication and/or store such information for subsequent processing, e.g., add the end user to a mailing list, h) pass along billing information, which billing information may be determined before, during and/or after the end user's initial request, response to one or more questions, actions before or after responding to any such questions, i) receive a response from a party that may be billed, e.g., to determine if one or more advertisers wish to respond to the end user or present one or more questions based upon the search string, and/or survey questions, and/or the end user's responses to one or more questions, and/or the cost based upon any of the following in the event the end user clicks on the advertiser's link or advertising or otherwise purchases a good or service from one or more advertisers, and j) store data in a database of the transaction, results, click through information, etc., for subsequent learning and other uses and k) pass required data to the billing program to send billing information to all appropriate parties and manage and track collections related to each transaction and/or the customer service program, which may include features to follow-up with the end user to ask additional questions and/or request the end user to fill out a customer satisfaction survey.

Mapping Program 94 may be configured to permit a maintenance person or other authorized party to set up data mapping instructions, including the ability to: a) select one or more tables and/or data elements within such tables from the survey results database, b) determine target or receiving applications, vendors, advertisers, etc. c) transform one or more data elements through built-in or custom applications or algorithms and/or data filters or masks, which may include one or more of the following i) truncation, ii) fill or padding blank spaces, iii) mathematical operations including rounding up, down, off, or multiplication, division, addition, subtraction, or any other mathematical operation, iv) logic expressions, including if/then/else logic, and other Boolean operations, d) lookup and replace operations, e) and/or any other operation, logic, step or program, and/or any combination or order of any of the forgoing or any other programming actions, such as the use of business logic or rules, all of which is well documented within the prior art and would be readily apparent to anyone with ordinary skill in the art. Such mapping instructions may be facilitated with the use of a graphical user interface to aid maintenance persons in selecting source data and pointing to target database fields. Such user interface may also aid the maintenance persons in selecting the proper data transformation process(es).

Data Transfer Program 96 may be configured to transfer data from the survey application or program to one or more vendors (i.e., advertisers) or other websites or applications. Using information contained in the mapping database application, this program may transfer one or more data elements concerning the end user and the responses to questions provided by the end user. Data may be transmitted “as is” leaving the mapping function up to each individual vendor or advertiser, or, as previously described, such data may be manipulated according to rules or other mapping instructions established within the mapping program itself, e.g., default mapping actions, or via instructions and/or algorithms supplied by maintenance persons. This program receives the survey results from the survey program and transmits the data to the receiving program and/or stores the data into the receiving application's database(s), again, with or without transformation of data and/or mapping occurring. The receiving program then may make use of one or more of the data elements to determine if additional questions are required, in which case the survey program may be invoked or another vendor proprietary survey application may be invoked. In addition or in the alternate, such data may be used by the receiving application to determine if the vendor desires or is otherwise willing to pay for a link or advertisement or other information to be displayed or otherwise transmitted to the end user and/or to determine if the vendor is willing to participate in an auction process for the right to display an link, ad, or other information and/or to determine such vendor's position or rank in a sorted list of multiple participating or bidding vendors, etc., and the amounts (i.e., upper and lower bounds) that such vendor would be willing to pay, or the increments to increase a bid until such upper bound is reached, and/or such information may be used to determine if a receiving vendor is willing to pay for the transferal of such information to and use by said vendor(s).

Billing Program 100 may be configured to receive information from the survey program and send bills to any affected parties and to monitor their payments, including monitoring of aging accounts, etc. and/or to automatically obtain payment for the delivery and/or use of information supplied and/or for the display of any link, advertisement, or other vendor information.

According to an embodiment, system 90 may be configured to perform some or all of the following method steps:
1. Open all databases when and as needed
2. Initial Vendor Setup
3. Billing Information Setup
4. Questions and Answers Database Setup
5. Create Mapping Instructions or Rules
6. End User Enters Search String
7. Search Engine (or other application, e.g., survey program) Determines If Survey Questions Are Required or Useful
8. If required or recommended, search engine (or other application) displays questions and gathers results from end users
9. Mapping Program transforms data as required by transformation algorithms or rules or other predefined programming steps
10. Transfer Program transfers the data to the receiving party (e.g., a vendor program, application, communications package or vendor database)
11. Vendors are notified of potential customer(s) and results of survey questions and costs for each
12. Vendors determine if they wish to use results
13. Vendors determine if they wish to have a link, advertisement or other information displayed to end user and/or to automatically redirect the end user to a vendor's site
14. Participating vendors that agree to charges receive information via the transfer program
15. Search engine displays link, advertisement or other information and/or redirects the end user as determined and for those participating vendors that have agreed to charges for such displays or redirection of end users.
16. Billing Program determines billing amounts and records bills and sends invoices (electronically) and/or automatically collects payments to all appropriate or affected parties.
17. Update all databases as and when needed
18. End user either modifies the search string or selects from among the links, ads or information.
19. If the end user modifies the search string, start at top
20. If end user selects a link, ad or information, transfer program control to destination website, link, ad, etc.
21. Else, await further end user action.

According to another embodiment, system 90 may be configured to perform some or all of the following maintenance method steps:
1. Open all databases when and as needed
2. On-going Vendor, Questions, Rules, Billing, Data Mapping and Transformation database maintenance.
3. Such maintenance may be performed by any one or more of: a) Search engine or vendor database maintenance personnel or persons, b) owner of system providing questions and/or billing, c) end users (for end user databases), etc.
4. Update databases as and when needed

According to another embodiment, the present disclosure provides a method and system to select optimal digital advertisements from a vendor or system provided group of advertisements to be displayed in response to a keyword search.

In an embodiment of the present invention, a search engine or other web site, further processes a search word, keyword or search string to better determine which vendor or advertisers should be listed in response to such search word, keyword or search string and/or in response to answers supplied by end users to survey questions.

In today's search environment, oftentimes, end users enter suboptimal search words or phases. Using surveys such as those described herein, can help determine and/or prioritize a list of vendors and/or advertisers in response to a user-supplied search word or phrase.

Once such a list has been determined using all available information and methods as described herein, it would be further beneficial to determine the order in which such vendors or advertisers should be listed and/or to determine which advertisement might be most effective given the search word, keyword, or search string and/or survey responses supplied by the end user, and/or based upon synonyms of the supplied information.

In this manner, vendors or advertisers can be better assured that the optimal advertisement, and placement thereof, is generated and displayed to the end user.

In another embodiment of the present invention, the system permits end users, and/or vendors and/or advertisers, and/or search engine companies and/or third parties to enter any or all of the search words, keywords, search strings, survey questions, ideal responses, advertisements, synonyms, or any combination of these and/or to maintain or revise these over time.

In another embodiment, such information is determined and learned through use of the system over time through use of statistical methods and/or through use of neural nets, expert systems, genetic algorithms or any other known algorithms in the prior art.

As the system learns which methods are most effective, the system can modify subsequent output results geared to ensure optimal results. Owners and/or managers of the system could set the business logic or rules and/or fitness tests to enable the system to determine the definition of “best results” and/or the definition of “optimal.” For example, optimal might mean the highest click through ratios, or it may mean the greatest amount of revenues generated for the search engine or for the vendor or Advertiser, and/or it may mean overall satisfaction of the end user or the search engine provider or the vendor or advertiser, or it may mean a combination of these or any other business drivers as agreed upon by the affected parties or those parties authorized or are otherwise in a position to make such determinations. Multi-determinant systems and learning methods are well defined and well known within the prior art and therefore are not more fully defined herein.

Click through rates can be optimized based on:
1. The search engine or website where the advertisement is displayed
2. The end user historical search profile
3. The end user personal information profile
4. Synonyms of the search word or string or keyword(s)
5. Customer, vendor, advertiser, search engine provider, or any other effect third party's satisfaction with the search engine, survey program, synonyms, advertisement program, vendor, and or advertiser's products, services, applications and/or the disclosed invention.
6. The revenues expected or actually generated (either initially or over the long term) by the search, survey, or advertisement programs for the search engine and/or the advertiser or vendor or any combination of these.
7. The speed with which an end user finds the desired link, product, good or service.
8. The degree to which the end user complies with or supplies answers to the survey program and/or selects a link, synonym, or vendor and/or advertisers' product, good or service, or visits a website or requests additional information from any or all of the forgoing.

Once survey questions and/or advertisements are determined, the system can either pass the information to the calling program, e.g., a search engine, and/or display such results in a separate window or webpage.

End users may then refine their searches, select a link, synonym, advertisement, vendor, etc., or quit the program.

In an embodiment, when end users find what they are looking for, as evidenced by their selecting a link or buying a product, or answering a survey question, or requesting additional information or by choosing a synonym, or any combination of these or by taking any other action as a result of any refinements, suggestions, conclusion or actions taken or suggested by the present invention, the system can learn from each such action, be it favorable or unfavorable. In this manner, the present invention can continuously improve results overtime, thereby improving the results as defined within the system, e.g., increase in sales, click through rates, customer, vendor or advertiser satisfaction, or any combination of these or other defined objectives or results.

According to another embodiment, the system can write potential advertisements for the advertiser based on the selected keywords and/or the html text of the website the advertiser is promoting, and/or by combining keywords and/or html text and/or existing advertisements to create a new advertisement and/or a combination of these (collectively a “dynamic advertisement”). The vendor can approve the advertisements before they are displayed, or the system can write and display advertisements without the vendor approval.

According to one embodiment, an additional fee can be charged by the keyword engine to provide the service of determining optimal advertisements and/or optimal display sort order based on click through rates and/or “conversion rates,” i.e., the percentage of end users that actually buy a good or service, and/or a separate fee for creating said dynamic advertisements.

In addition to advertisements, the vendor (and/or search engine and/or other third party) can select multiple survey questions to ask, along with corresponding answers before its advertisement or dynamic advertisement is displayed. The system can test which questions (and/or order of questions, and/or number of questions) and corresponding answers yield the highest click through rate on the advertisement that is subsequently displayed.

Combinations of Survey questions and answers could also be used as described herein. For example, in response to the keyword: Santa Fe, the end user could be asked to select a lodging type and whether or not they were interested in horseback riding. If the end user selects “lodge” as his lodging type and “yes” to horseback riding, a link and corresponding advertisement for a website can be displayed.

The position of the advertisement can also be tested and optimized. For example, an advertisement for a hotel in Santa Fe could be listed first when the end user enters the keyword Santa Fe Hotel, but could be listed third when the end user enters the keyword “Santa Fe, N.Mex.”—in addition or in the alternate, when a first end user enters the words Santa Fe Hotel, the advertisement for a specific hotel in Santa Fe could be listed first, then when a second end user enters the same search words, i.e., Santa Fe Hotel, the system might display the same advertisement in the second position and so on. In this manner, over time, the system can determine which position best suits the advertisement for that hotel.

In another embodiment, for example, the system can test from among two or more advertisements for said hotel and/or among multiple hotels, to determine which ads work best in each position for each hotel.

In another embodiment, for example, after gathering end user's responses, the search engine identifies one or more vendors that have a probability that the end user will select their good or service and then requests bids from such vendors to purchase a right to have their website link and/or marketing message or “tag line” displayed and/or the sort order of the list, i.e., their final position in the list, e.g., third from the top.

In another embodiment, for example, based upon a respondent's answers (which information may or may not be combined with the search string entered into such a search engine and/or synonyms, in addition to determining a list of providers to display, the system may determine a dynamic marketing or company or product description to include with each provider's listing. Such dynamic marketing “tag line” may be modified to be more appropriate given the respondent's answers and/or any other information available about the respondent and/or the provider or list of providers selected for display. For example, if a respondent entered the search string “horse ranch vacation” into Google, the system might ask the question “are you looking for formal riding or western style dude ranch?” The respondent might respond by clicking a check box next to dude ranch. In that case, horse ranches and dude ranches in the western states, such as New Mexico, might be listed. One or more of such providers might pay for preferential positioning and/or dynamic tag line listing, and/or a subsequent question might be asked to further refine the respondent's needs. In either case, the marketing tag line for a given provider might be selected from among two or more possible tag lines.

In another embodiment, the system learns which marketing tag lines are most effective given a respondent's answers, preferences or other attributes including the respondent's personal information, buying history, etc., and/or the provider(s)’ attributes, need for sales, or past success with similar respondents. The system might initially present the provider's primary or preferred marketing tag line, or, randomly test tag lines to learn which tag lines produce optimal results given the available information about a given respondent. In addition or in the alternate, the system might learn using any of one or more learning systems that are well known within the art, including neural nets.

Tag line content may be created by the search engine, provider or a third party. There may be a limit or no limit to the number of available tag lines.

In another embodiment, the sort order of the list of providers (or products/services) may be determined based upon the probability that a given respondent will ultimately become a customer (by purchasing a good or service) in addition to or instead of being based upon a preferential fee paid by one or more providers.

In another embodiment, for example, based upon the success of surveys driving sales to a certain class or type of business or provider, the system may produce reports to aid search engine companies to identify other possible providers that are not yet subscribing to the search engine marketing service. In addition or in the alternate, the system might send marketing messages to such targeted prospective vendors automatically, providing in such marketing materials any one or more of the following information including but not limited to the total number and percentage of: a) searches, b) respondents, c) conversions, d) sales, e) summary or detailed demographics, etc. In this manner, additional providers may participate, increasing the revenues for the search engine site and improving the odds that any given respondent will find the most desirable good, product or service.

In another embodiment, the list of providers may be based and/or dynamically adjusted based upon any one or more of the following, including but not limited to: a) the revenues generated for the search engine, b) the revenues generated for the website hosting the survey (which may or may not be the search engine site), c) the revenues generated for the provider, d) the conversion rate of prospects to customers, e) the satisfaction of the respondent with the list of providers and/or the selected provider, f) the satisfaction with the final product, good or service provided by the provider (which information may be gathered by sending a follow-up questionnaire that contains one or more questions, such questionnaire might be sent via e-mail or regular postal mail service, or g) the speed with which the respondent concludes his search and/or purchase.

Learning can be accomplished by tracking statistical information, or by using any of several learning or adaptive agents/systems/methods that are well known within the art such as Bayesian algorithms.

In an embodiment, selection of an item from a list of items (e.g., links and/or synonyms) may equate to “answering a question.”

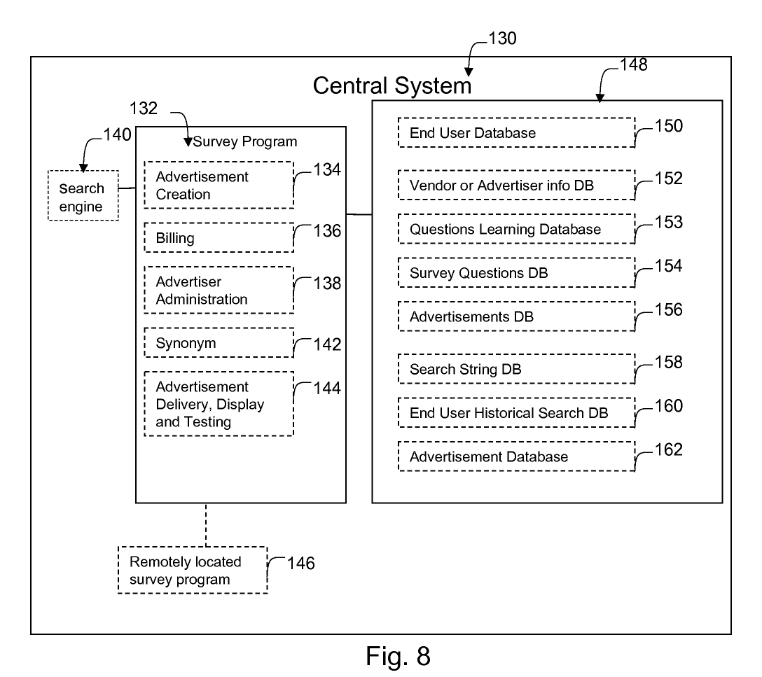

FIG. 8 provides a system 130 according to one embodiment of the present invention. As shown, system 130 may include an Advertisement Creation Program 132. Advertisement Creation program 130 may be configured to permit the manual or automatic creation (or any combination of these) of advertisements for each advertiser and/or class or group of advertisers. Each advertiser can have one or more advertisements associated with the advertiser in general and/or for each product and service and/or for each keyword and/or search string. The number, length and type of ad can be fixed or variable as determined by the advertising company, e.g., search engine company, and/or as agreed upon by any or all affected parties and/or as determined by a learning algorithm that determines the best length of each ad based upon overall results, and/or results for each category or type of advertiser and/or each specific advertiser and/or each specific product, good or service offered by each advertiser or any combination of these. Ads may be entered manually by search engine, advertising company and/or advertisers or their designees or any combination of these and/or may be created automatically from base words, phrases, strings or paragraphs. Advertisements and/or tag lines may be entered and/or generated and or modified at any time by any authorized party. In the event that advertisements are created manually by anyone other than the advertiser and/or automatically, the system may or may not be required to obtain the advertiser's approval of any such new or modified advertisement prior to use or insertion into the advertisement database.

System 130 may further include a Survey Program 134. Survey program 134 may include static and/or dynamic survey questions. The program may determine which end users will receive questions and which questions will be presented. Selection of questions may be based upon any one or more of the following, for example: a) the search engine, b) the end user, c) the end user's profile, d) the end user's search string or query, e) the advertisers listed by the search engine, f) a probability of a purchase by an end user as determined by the outcome of previous searches and/or responses to similar or the same survey questions and/or end user demographics and/or any combination of these factors. Questions may be predetermined, i.e., fixed questions based upon specific search strings, and/or randomly selected, and/or determined by a learning algorithm, such as a Bayesian logic or a neural net, or other learning methods that are well known in the art, and/or established by the advertiser(s) and/or service providers, and/or search engine provider, and/or any combination of these, and/or by using an expert system or other rules based system(s) which are well known in the art. Questions may be changed overtime by any of the forgoing, and/or new questions may be added to the database for subsequent presentation and testing for success and/or click through rates. In addition to the forgoing, the survey program's primary purposes are to a) evaluate each end user, using any information available at the time a query or search string is submitted (e.g., end user demographics, search engine type, search string contents, search engine query response list and advertisers, etc.), and then determine which survey question(s) are most appropriate to present to the end user, b) present the appropriate question(s) directly to the end user or pass the information to the search engine or requesting website for subsequent presentation to the end-user, c) receive and process responses from the end-user (whether directly or by receiving the response from the end user or the end user's search engine's website or the requesting website or otherwise, e.g., a travel site with an embedded survey program), d) determine which new or additional list(s) of advertisers, advertisements, or links or otherwise are most appropriate given the answer(s) to the one or more presented survey question(s), e) present the new or modified list as determined in the previous steps, to the end user or pass the results to the requesting program, e.g., the search engine or travel website, f) await the results of any subsequent actions taken by the end user, such as the end user clicking on any one or more of said links or modified or new advertisers, or links, and pass any appropriate and/or available information to all interested and/or affected parties, including, but not limited to, for example, the search engine, travel site, other website or link, etc., e.g., any third party that may benefit from or be affected by the actions (or inaction) by the end user and/or those that may be charged for the presentation of the questions and/or charged based upon the subsequent decisions, purchases, clicks, actions or otherwise by the end-user or those affected or that could be affected or benefit by or from such knowledge about the end user, and/or the end user's search string, responses to one or more questions, actions or failures to act or respond to any subsequent modified or new list of advertisers and/or links, or otherwise, g) pass any part or all of said results to any participating or otherwise affected parties as appropriate or as agreed upon by and between the requesting website, e.g., search engine or travel site or city website, or advertiser website, etc., so that any interested and/or affected parties can take any subsequent or further action, e.g., display a webpage, or an advertisement, or link, or send a package of information via e-mail or mail, or via other form of communications and/or store such information for subsequent processing, e.g., add the end user to a mailing list, h) pass along billing information, which billing information may be determined before, during and/or after the end user's initial request, response to one or more questions, actions before or after responding to any such questions, i) receive a response from a party that may be billed, e.g., to determine if one or more advertisers wish to respond to the end user or present one or more questions based upon the search string, and/or survey questions, and/or the end user's responses to one or more questions, and/or the cost based upon any of the following in the event the end user clicks on the advertiser's link or advertising or otherwise purchases a good or service from one or more advertisers, and j) store data in a database of the transaction, results, click through information, etc., for subsequent learning and other uses and k) pass required data to the billing program to send billing information to all appropriate parties and manage and track collections related to each transaction and/or the customer service program, which may include features to follow-up with the end user to ask additional questions and/or request the end user to fill out a customer satisfaction survey.

System 130 may further comprise a Billing Program 136, which may be configured to receive information from the survey program and to send bills to any affected parties and to monitor their payments, including monitoring of aging accounts, etc.

System 130 may further comprise an Advertiser Administration Program 138. Advertiser Administration program 138 may be configured to store and process information about advertisers, including but not limited to advertisers, advertisers, service providers, search engine companies, travel companies, localities, etc., regarding their desire to participate in the survey programs, their payment terms, their preferences regarding types of end users, survey questions, sequences or priority of questions, answers, limits on costs or billing, payment preferences and payment information, e.g., credit card or other terms, presentation preferences, e.g., order in list of advertiser links, advertisements, willingness to bid on one or more end users, or end user types, or end user responses to specific or generic survey questions, etc., and their willingness to participate in an auction or other sale of prospective customers.

System 130 may further comprise a Search Engine 140. Search engine 140 may be configured to parse the search string using any of many well know methods such as those used by Google, to determine an initial list of advertisers, search results, sponsors etc., and then to pass the information to the survey program, which may be resident and an integral part of the search engine application or which may be a separate program running on the same equipment or on a separate server or website or any combination of these.

In an embodiment of the present invention, the search engine user interface is also used to present and process the user interface components of the survey questions. In another embodiment, the survey questions appear via a separate webpage or “window” that operates independently of the search engine's user interface and/or application. In another embodiment, the results of the survey questions are returned to the search engine for subsequent processing, e.g., to modify the original list of advertisers, results and/or sponsors, given the end user's responses to the survey questions. In yet another embodiment, the revised list of advertisers, results and sponsors appear on a separate “window” or webpage, which webpage may or may not be generated or displayed or managed by the calling search engine.

Methods to analyze an end users search string and methods to improve such analysis is already well known within the prior art and it will be appreciated that there are many methods that could be employed to perform the initial and/or subsequent parsing of the search string and/or the survey questions in order to determine the best advertiser or list of advertisers and/or search results based upon either the search string and/or the survey questions individually or collectively. Furthermore, anyone skilled in the art of learning systems would readily appreciate that various methods could be employed to enable the system to learn from the search string(s) entered and/or any available end user demographics and/or any responses to any survey questions, each individually and/or in any combination so as to permit the system to improve the results or outcome for any given transaction, e.g., search and/or survey over time. Improved results may mean any one or more of a) revenues generated (short or long term), b) end user satisfaction with the search engine and/or the survey questions and/or the survey process, c) advertiser satisfaction based upon end user reported satisfaction, and/or revenues received and/or revenues received vs. the cost for such revenues, i.e., fees charged for the search and/or survey, d) click through rates, e) search engine company satisfaction based upon revenues generated by the search and/or survey results and/or received by advertisers, and/or advertiser reported satisfaction, and/or end user reported or surveyed satisfaction, f) any other business logic, rules or success criteria determined by the search engine company and/or the advertisers and/or the owner/operator of the survey application or any combination of these.

System 130 may further comprise a Synonym Program 142, which may be configured to determine and/or retrieve possible or known synonyms to a word or search string. This program may be manually administered, e.g., humans can create a list of synonyms and/or it may be automated. An automated program may start with a known list of synonyms such as the list contained in Merriam-Webster's dictionary of synonyms, or it may start with no known list of synonyms, or a subset of synonyms. The program can learn which words are synonyms in any one or more of the following ways including a) associating words entered by end users, with words actually or finally selected by end users, b) by observation of click through activity, c) manual entry by end users, advertisers, service providers, search engine operators, or any authorized third parties, or d) through use of any of several well known learning algorithms. As the system increases its list of synonyms, the relevancy of one word to another word or a group of words to a word or a group of words can be determined over time via manual or automated methods. As these associations become known or their relevancy is determined or refined, synonym program can store the synonyms and their relevancy to each other for subsequent use. In and embodiment of the present invention, such synonyms are used to a) be displayed to end users and/or passed to search engines or other websites or applications to be used to improve search results (such display or use may or may not be associated with the Survey Program, e.g., as end users enter search words or strings, the Synonym Program may begin immediately displaying synonyms on the search results or other results page for reference and/or use by the end user, and/or the search engine may use such synonyms to display to the end user and/or use the information to improve its search engine algorithm's results and/or to help improve sorting the results so that they may be more relevant given the search word or string. In another embodiment, the survey program uses synonyms to help determine relevant survey questions and/or to improve its result sets, e.g., choosing relevant advertisers or other third parties based upon the synonyms and/or answers to survey questions or any combination of these.

System 130 may further comprise an Advertisement Delivery. Display and Testing Program 144. Advertisement delivery, display, and testing program 144 may be configured to determine which advertisements should be displayed, determine the ideal question order, and test to determine which are more effective given the keywords or search string(s) entered, the advertisers displayed, synonyms, end user or advertiser information, business logic, rules, and/or any other current or historical information available at the time. If appropriate, the system may also display the advertisements, and/or transmits the advertisements to the search engine or other third party site for subsequent end user display. The system may test the results and may use any statistical and/or learning algorithms that are known in the prior art, such as a genetic algorithm or a Bayes classifier system.

System 130 may further comprise a Survey Program 146 and/or a communications link to a remotely located survey program.

System 130 may further comprise one or more databases 148. It would be readily apparent to anyone skilled in the art that various methods of designing the system, programs and or databases are available and that certain of the information may not be required and/or additional supporting information may be included that may improve the performance of the present invention. For example, certain of the data may be encrypted to ensure end user privacy.)

Databases suitable for use in system 130 may include one or more of:
1. End user information database 150, which may track and store information such as:
   a. End user ID or IP address
   b. End user Password
   c. End user name and address
   d. Demographics
   e. Prior history database
   f. Preferences
   g. Questions and/or response
   h. Billing information
2. Vendor or Advertiser information database 152, which may track and store information such as:
   a. Advertiser ID
   b. Advertiser Password
   c. Advertiser Name
   d. Advertiser Website Address (1-n)
   e. Payment Terms
   f. Payment Type
   g. Credit or other Payment instrument (e.g., wire transfer or billing information)
   h. Fee Options, e.g., cost for one, two or more advertisements, static and/or dynamic, and/or tests for variable positions and/or variable ads, and/or use of synonyms and/or use of surveys.
   i. Advertiser address
   j. Advertiser question IDs 1-n
   k. Advertiser preferred or ideal responses to each question above 1-n
   l. Questions weighting factors (e.g., which are more or less important) 1-n
   m. Additional fee option (e.g., willingness to pay more given certain survey question responses.
   n. Advertisement weighting factors (e.g., which are more or less important and/or more or less effective) 1-n
   o. Additional fee option (e.g., willingness to pay more given certain survey question responses and/or advertisement selection, e.g., selecting an ad for a hotel with a description of “first class accommodations” may require an advertising fee greater than an add for the same advertiser and same hotel but using an add reading: “great weekend deals”.
3. Questions Learning Database database 153, which may track and store information such as:
   a. Relevancy Score
   b. Answers Ranking Score
   c. Order Preference Ranking/Relevancy
4. Survey Questions Database database 154, which may track and store information such as:
   a. Question ID
   b. Question Name
   c. Question Type
   d. Question Category
   e. Sequence Number
   f. Subsequent Question ID (1-N)
   g. Keywords (1-N)
   h. Keyword Relevancy Scores (1-N)
5. Advertisements Database database 156, which may track and store information such as:
   a. Advertiser ID
   b. Product, Service, or Good ID (1-N)
   c. Description (1-N)
   d. Keywords/Search Strings (1-N)
   e. Advertisements (1-N)
   f. Advertisement Effectiveness Score by Position (1-N)
   g. Advertisement Effectiveness Score by Keyword or Search String (1-N)
   h. Click Through Rates for All of the above (1-N)
   i. Actual and average Revenues Generated for each of the above (1-N)
6. Search String Database database 158, which may track and store information such as:
   a. Search String (may be specific string or group or category of strings)
   b. Related Search Strings (i.e., synonyms) 1-N
   c. Survey Question Ids (1-N)
7. End User Historical Search Database (End user specific) 160, which may track and store information such as:
   a. End User Ids (1-N)
   b. Search Strings/Keywords (1-N)
   c. Search Results
   d. Links or Ads Selected (1-N)
   e. Frequency and Relevancy Scores (1-N)
   f. Synonym Results and Relevancy Scores (1-N)
8. Advertisement Database 162, which may track and store information such as:
   a. Keyword or Search String (1-N)
   b. Synonyms (1-N)
   c. Advertisements (Generic—1-N)
   d. Advertisements by Advertiser (Specific—1-N)
   e. Relevancy Scores (1-N)
   f. Click Through Rates Specific (1-N)
   g. Click Through Rates Generic (1-N)

According to an embodiment, system 130 may be configured to perform some or all of the following:
1. Enter, Create or Update Advertisements
2. Enter, Create or Update Survey Questions and Responses
3. Deliver and/or Display Advertisements and Test Advertisement Click Through Rate
4. Test Survey Response Click Through Rate
5. Determine Optimal Advertisement for a Keyword Based on Test Data
6. Determine Optimal Survey and Answers Based on Test Data

According to an embodiment, system 130 may be configured to perform an Initial System Setup (Advertiser Driven) by facilitating the following method steps:
1. Advertisers enter information via the Advertisers Administration Program
2. Advertisers add Advertiser information and questions into Survey Questions Database
3. Advertisers add Advertisements into the Advertisements Database
4. Advertisers link survey questions to search strings and rank each question in terms of relevancy
5. Advertisers rank possible responses in terms of relevancy and value
6. Survey Display Program calculates fees and requests Advertiser approvals
7. Advertisers approve fees
8. Advertisers link advertisements to search strings and rank each advertisement in terms of relevancy given a search string and/or keyword(s)
9. Advertisers rank advertisements in terms of relevancy and value
10. Advertisement Display Program calculates fees and requests Advertiser approvals
11. Advertisers approve fees

According to an embodiment, system 130 may be configured to perform an Initial System Set up by a Search Engine Company by facilitating the following method steps:
1. Search engine company employees or designees or vendors enter information via the Advertiser Administration Program
2. Search engine company employees or designees add Advertiser information and questions into Survey Questions Database
3. Search engine company employees or designees link survey questions to search strings and rank each question in terms of relevancy
4. Search engine company employees or designees rank possible responses in terms of relevancy and value
5. Survey Display Program calculates fees and requests advertiser approvals
6. Advertisers approve fees
7. Search engine company employees or designees add Advertiser information and advertisements into the Advertisements Database
8. Search engine company employees or designees link advertisements to search strings and rank each advertisement in terms of relevancy
9. Search engine company employees or designees rank advertisements in terms of relevancy and value
10. Advertisement Display Program calculates fees and requests advertiser approvals
11. Advertiser approve fees

According to an embodiment, system 130 may be configured to perform Survey Operations by facilitating some or all of the following method steps:
1. End user enters search string on search engine or other website
2. End user may enter additional information
3. Search string and preliminary results are passed to the survey program
4. Initial results may or may not be immediately displayed while the survey program conducts its analysis and/or while the Advertisement Delivery. Display and Testing Program executes and delivers its preliminary results
5. As or if available, retrieve, End User information, Vendor Information, Rules, Survey Questions and rules or business logic from the databases
6. Survey program, using as much information as is made available, determines appropriate survey questions, number, type and sequence
7. Survey program presents one or more questions in the appropriate order to the end user (or the calling program, e.g., search engine as appropriate)
8. End user enters one or more responses to survey questions or ignores them or quits
9. End user may enter additional information, e.g., name, address, income level
10. If end user answers the questions, answers are analyzed by the survey program to determine which specific vendor or category of vendors or list of vendors that best match initial search string and survey responses given business objectives and/or rules, and/or learning algorithms results and/or expected revenues and/or a combination of the above and/or determines applicable synonyms by executing the synonym program.
11. Execute the Advertisement Delivery. Display and Testing Program
12. Survey and Advertisement programs pass results to search engine (if required/applicable)
13. Survey program (or Advertisement Program and/or search engine) presents modified results to end user, which may include a modified list of advertisers and/or a modified list of advertisements and/or a modified sort order of any or all of these.
14. End user either selects from among the modified list(s) or enters a new search string, or selects a synonym or quits
15. If the end user selects from the modified list(s), display the appropriate webpage(s), update the database
16. If user enters a new search string and/or selects a synonym, restart the survey program using the new search string or synonym
17. Else, wait for further end user response and/or execute vendor “proactive” ads and/or update databases and return to start.
18. Execute Billing Program and pass results of end user activity and search results
19. Execute Learning Algorithm
20. Update databases
21. Wait for further end user, search engine or advertiser instructions/actions
22. Return to start

According to an embodiment, Billing Program 136 may be configured to:
1. Receive results from Survey and/or Advertising Program including impressions information and click through results
2. Retrieve billing rules and payment terms from database
3. Determine charges
4. Notify affected vendors, advertiser(s) or other third parties of fees/charges and payment terms
5. Update databases
6. Await payment
7. If payment is not made timely, notify vendor(s), advertiser(s) or other delinquent parties and place a hold on subsequent surveys and/or advertisements for said vendor(s), advertiser(s)/ and/or third parties and/or charge a fee (which may be higher) to the delinquent party's credit card on file.

According to an embodiment, Synonym Program 142 may be configured to:
1. Receive search word or string (or portions thereof) from end user or search engine or website, etc.
2. Look up individual words and/or strings within synonym database.
3. Retrieve synonyms and rank according to relevancy to search word or string
4. Retrieve display results rules
5. Send results and display/use rules to search engine and/or website and/or survey program as required and applicable
6. Display synonyms as applicable and according to display rules (if any and as required)
7. Receive indication that end user or third party clicks on synonym
8. Update relevancy database
9. Execute learning algorithm

According to an embodiment, Advertisement Delivery, Display and Testing Program 144 may be configured to:
1. Receive list of one or more advertisers from calling program
2. Receive keywords and/or search string and/or synonyms from calling program
3. Retrieve data from advertiser, advertisement, billing, advertisements, end user, end user history, and other databases.
4. Determine which advertisement to optimally display for each listed advertiser and the optimal location (e.g., sort order) for each advertiser.
5. Return results to calling program and, if applicable, to the search engine or other third party website.
6. Await end user response, e.g., click through
7. Execute learning algorithm
8. Execute Billing Program
9. Update databases

According to another embodiment, any of the systems described herein could employ a Hotel Revenue Manager configured to set parameters for pricing at a given hotel (or set of hotels). The system could be set to update the prices on various travel-related search engines such as Expedia, Priceline, Travelocity, etc., accordingly.

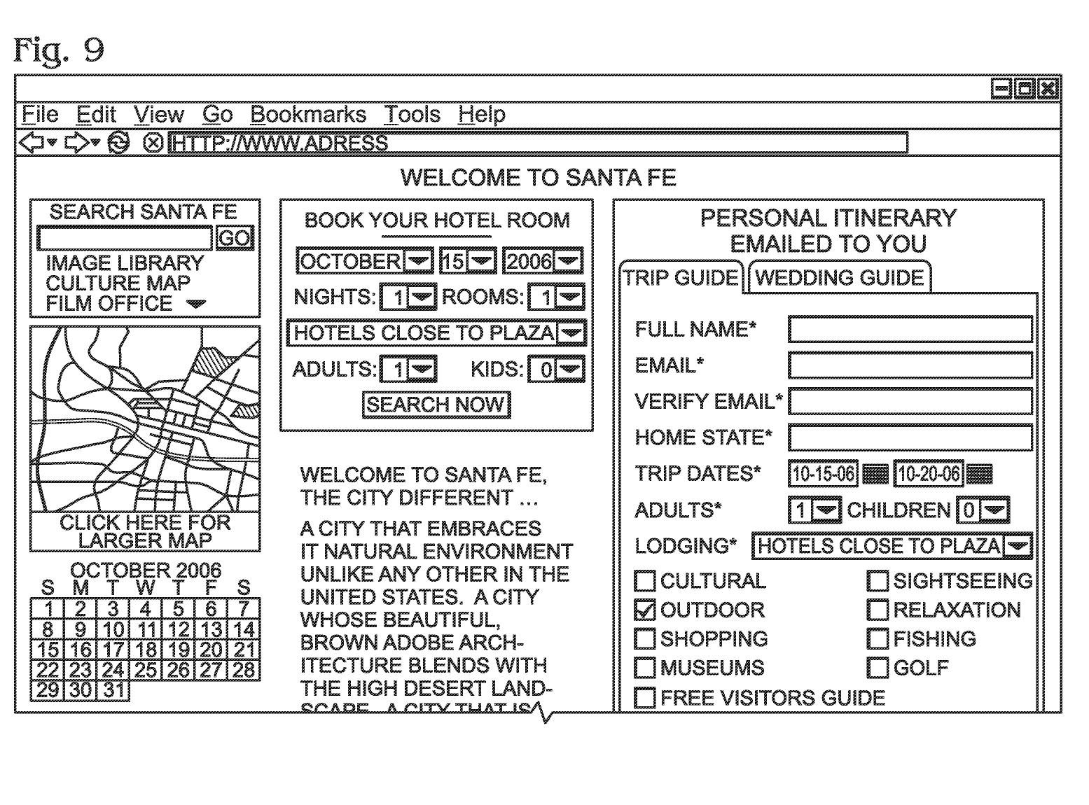

FIG. 9 is a schematic screen shot of a travel-based web site 200 incorporating a survey 202 according to an embodiment of the present invention. It will, of course, be understood that the present embodiment should in no way be limited to travel-based web sites, but, instead, will be applicable to limitless numbers of goods and services available via an on-line purchasing system. As shown, the survey could be provided as one of several frames that are displayed to the user upon reaching a given website. The survey 202 may be part of content provided by the owner of the travel (or other) website, or may be owned by a third-party and linked to the website.

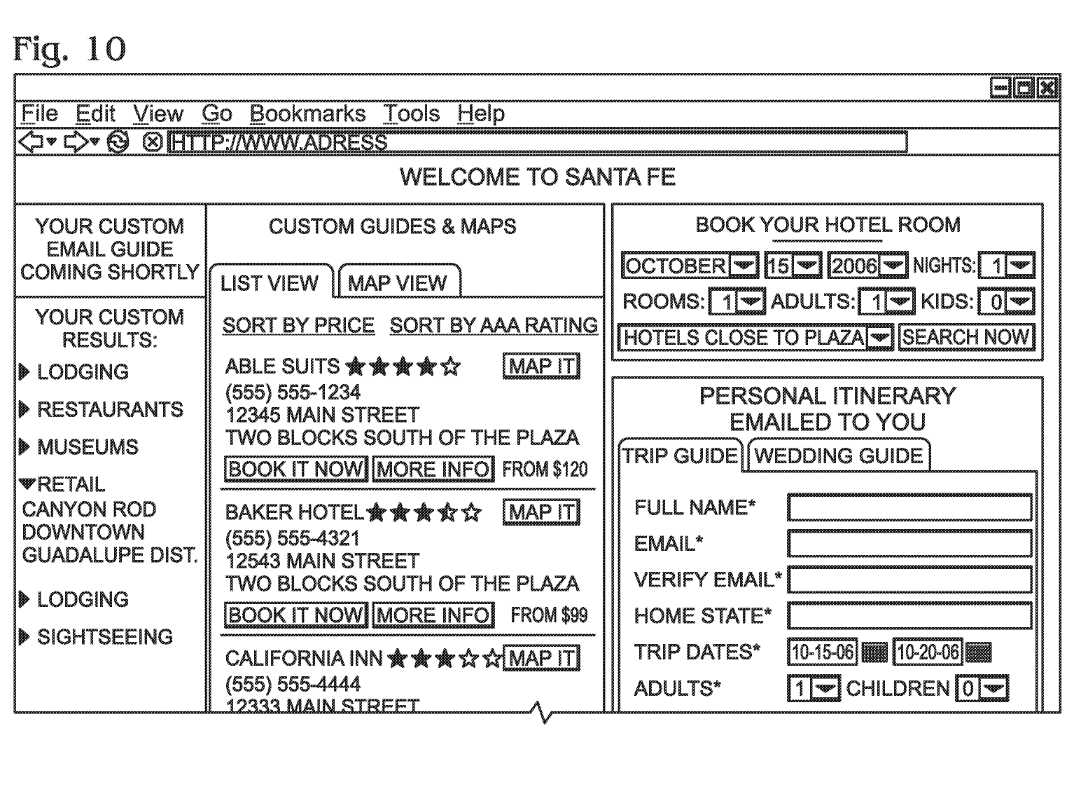

FIG. 10 is a schematic screen shot of a hotel reservation web site incorporating a survey according to an embodiment of the present invention. As in FIG. 9, the survey 202 may be provided by the owner of the hotel reservation web site or may be owned by a third-party and linked to the website.

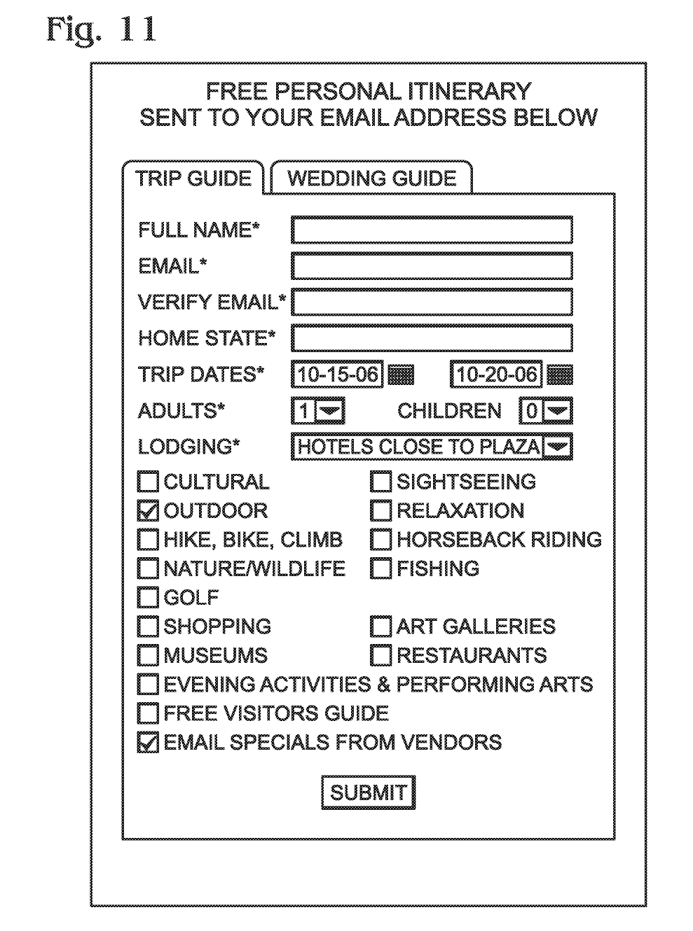

FIG. 11 depicts one embodiment of a survey 202 according to the present invention. As shown, the survey may ask for various types of information including the desired dates for the trip, the number of travelers, and the desired general hotel location.

According to one embodiment, a central system receives the user's answers (i.e. desired criteria) to the survey and determines which vendors have inventory that satisfies the user's criteria. For example, a hotel A may have rooms available for the user's desired dates of travel, but may not be within the desired location, hotel B may be in the desired location, but not have rooms available for the desired dates. However, hotels C, D, and E may all be within the desired location and have rooms available for the desired dates of travel. Accordingly, only information about hotels C, D, and E may be provided to the user.

It will be appreciated that such a system may be used for non-hotel goods or services. For example, a consumer may indicate an interest in purchasing a given brand of golf clubs in a given city. The central system may have access to the current inventory of several sporting goods stores in the city and be able to provide the consumer with a list of stores who not only sell golf clubs, or the desired brand of golf clubs, but also have the desired brand of golf clubs in stock.

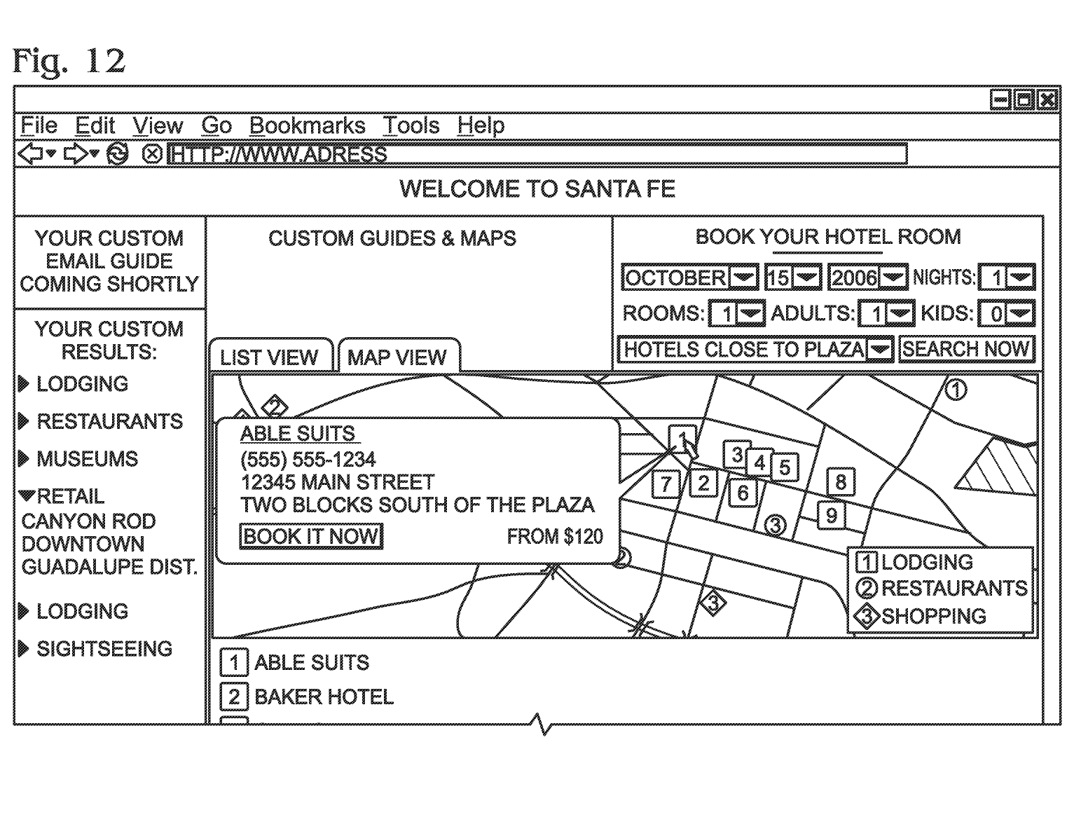

According to a further embodiment, a map is generated depicting the location(s) of any vendors whose current in-stock inventory satisfies the user's criteria. An exemplary interactive map is shown in FIG. 12. In this example, the user requested hotels close to the Plaza in Santa Fe that had rooms available from October 15^{th} to October 20^{th}. In the depicted embodiment, eight hotels, each indicated by a different number, were found that were both near the Plaza and that had rooms available during the stated time period.

Furthermore, the numbers or icons indicating the vendors may vary by color, size, shape, or other encoding to indicate any one or more of:
1. distance from the indicated desired location; destination, or other address or location
2. amount of available inventory
3. relative price
4. specials, discounts, packages, or other available offers
5. degree of match to user-specified criteria
6. membership in a frequent-buyer or other membership-based program

The map may also include the depicted feature whereby a user may scroll over any of the numbers indicating a hotel and receive additional information about the hotel such as name, phone number, address, pricing information, photos, hotel amenities, a link for room booking, information about special offers, degree of match to the user-specified criteria etc.

According to yet another embodiment, any vendor whose current in-stock inventory does not satisfy the user-specified criteria may be allowed to provide the user with an alternative offer. The alternative offer may, in some cases, may be an attempt to underbid or provide additional benefits to the user. For example, a hotel that does not have any rooms available for the user-specified desired travel dates may provide an advertisement indicating the dates when rooms are available and offering to discount the rooms by a certain amount. In some embodiments, vendors who wish to deliver such “non-matching” advertising to the user may be required to bid against each other for the right to do so.

According to one embodiment, vendors may be required to pay fees to the survey program provider, search engine, or a third party to participate in the system. The fee may be flat, based on the number of items sold, a percentage of sales, or determined by any other means. A vendor whose current in-stock inventory does not satisfy the user-specified criteria may be required to pay an additional fee to provide “non-matching” advertising to the user.

Accordingly, a system according to the present invention may be configured to receive information regarding a user's criteria for a given purchasable item or service via a survey. Upon receipt of such information, the system may be configured to identify vendors whose in-stock inventories are able to satisfy the user's criteria. The system may then output information to the user regarding the identified vendors. According to one embodiment, the output information may be provided in the form of a map.

Such a system may include, for example, a central server configured to host a survey program, a map generation program, an icon generation and coding program, a hover option program. The system may further include or be in communication with the inventory programs for each of the vendors. The system may further include any number of databases including, but not limited to, a GeoLocation Database, a Vendor database, an available inventory database, a vendor type database, an icon coding database, an offer rule database, and a hover rules database.

According to various embodiments, the system may be configured to generate a map with available reservations by performing steps such as:
1. Receive a survey request including dates and location
2. Determine vendors in location
3. Determine if vendors have available inventory
4. Generate and Output Map of location with vendors who have available inventory
5. Receive a request to book a reservation from the map
6. Retrieve and Output reservation form.

According to another embodiment, the system may be configured to suppress vendors with no available inventory that satisfies the user-specified criteria by performing steps such as:
1. Receive a survey request including dates and location
2. Determine vendors in location
3. Determine if vendors have available inventory
4. If vendors do not have available inventory, suppress vendor record
5. Generate and Output map of location with vendor records excluding suppressed vendor records
6. Receive a request to book a reservation from the map
7. Retrieve and Output reservation form

According to another embodiment, the system may include an icons and coding program configured to:
1. Receive indicator to display icon(s)/offer(s)
2. Load icon coding database
3. Determine icon/color coding
4. Load offer rule database
5. Determine secondary offers
6. Display icons and offers if applicable

According to another embodiment, the system may include a user hover option program configured to:
1. Load hover rules database
2. Receive hover indication
3. Determine if hovering over icon
4. If yes, determine secondary offer/messages
5. Display secondary offer/messages if applicable

According to another embodiment, any of the systems described herein could allow a non-selected provider the option of presenting a “last chance offer.” For example, if an end user selects ABC lodging, XYZ lodging might display a link that says: click here for half off lodging.

According to another embodiment, any of the systems described herein could employ customer ratings of hotel experiences to effect the commission charged by the survey provider and/or search engine to the hotel.

According to another embodiment, any of the systems described herein could employ a system in which customer ratings of hotel experience have the effect of eliminating or including rated hotels in future search results listings and/or a hotel's position within a list. Alternatively or additionally, an end user star rating system could be employed when conditions are similar to the failed effort(s).

According to another embodiment, any of the systems described herein could be designed such that, if the end user selects a synonym while typing the search string and/or after entering the search string, the results of that synonym are displayed instead of or in addition to the original search string results.

According to another embodiment, any of the systems described herein could be designed such that results for highly relevant search strings are updated periodically to improve performance.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. §1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a survey questionnaire to a user;
receiving answers to the survey questionnaire from the user including a set of criteria for a desired purchasable item;
identifying, from a set of vendors, one or more vendors whose in-stock inventory satisfies the criteria; and
outputting information regarding the one or more vendors to the user.

2. The method of claim 1 wherein the step of outputting information comprises generating a map indicating the location of the one or more vendors.

3. The method of claim 1 wherein the step of outputting information comprises providing an advertisement for the one or more vendors.

4. The method of claim 2 wherein the method of indicating the location of one or more vendors comprises providing vendor-specific indicia for each of the one or more vendors.

5. The method of claim 4 further comprising displaying additional information related to one of the one or more vendors in response to user-input.

6. The method of claim 5 wherein the user-input is provided when the user scrolls over the vendor-specific indicia.

7. The method of claim 1 wherein the desired purchasable item is a hotel room reservation.

8. The method of claim 7 wherein the set of criteria includes availability dates.

9. The method of claim 8 wherein the step of identifying one or more vendors whose in-stock inventory satisfies the criteria comprises identifying one or more hotels having an unreserved room during the availability dates.

10. A system comprising:
a vendor database providing a list of vendors offering purchasable items;
an inventory database for each vendor in the vendor database;
a survey questionnaire module configured to provide one or more survey questions to a user;
a criteria module configured to identify user-specified criteria based on answers provided by the user to the survey questionnaire;
an inventory pinging module configured to search the inventory databases and identify vendors that have inventory that satisfies the user-specified criteria;
an advertisement display module configured to provide information regarding the identified vendors to the user.

11. The system of claim 10 further comprising a map generating module configured to generate a map depicting the locations of the identified vendors to the user.

12. The system of claim 10 wherein at least some of the vendors are hotels.

13. The system of claim 12 wherein the inventory database for each vendor is the hotel's reservation system.

14. The system of claim 13 wherein the user-specified criteria is hotel location.

15. The system of claim 13 wherein the user-specified criteria is room availability for a given date range.

16. The system of claim 13 wherein the user-specified criteria is number of rooms available.

17. The system of claim 13 wherein the user-specified criteria further comprises a price range.

18. The system of claim 13 wherein the user-specified criteria further comprises hotel amenities.

19. A method comprising:
receiving answers to a survey from a user, wherein the answers specify a date and location for a desired hotel room;
identifying hotels in the specified location;
determining which of hotels in the specified location have a room available for the specified date;
generating a map identifying the location of the hotels that have a room available for the specified date;
outputting the map to the user.

20. The method of claim 19 further comprising:
receiving a request to book a reservation from the user;
retrieving a reservation form; and
outputting the reservation form to the user.
